(19) United States
(12) Patent Application Publication
(10) Pub. No.: US 2009/0314997 A1
(43) Pub. Date: Dec. 24, 2009

(54) SUBSTITUTED BENZODITHIOPHENES AND BENZODISELENOPHENES

(76) Inventors: Martin Heeney, Southhampton (GB); Weimin Zhang, Southampton (GB); Steven Tierney, Southampton (GB); Iain McCulloch, Southampton (GB)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/374,920

(22) PCT Filed: Jun. 29, 2007
(86) PCT No.: PCT/EP2007/005797

§ 371 Date: Jan. 23, 2009

(30) Foreign Application Priority Data
Jul. 26, 2006 (EP) 06015563.7

(51) Int. Cl. C07F 7/08; C09K 19/40; H01B 1/12

(52) U.S. Cl. 252/500; 549/4; 252/299.61

(57) ABSTRACT

The invention relates to novel substituted benzodithiophenes and benzodiselenophenes, their use especially as semiconductors or charge transport materials in optical, electro-optical or electronic devices and to such devices comprising the novel materials.

### FIELD OF INVENTION

The invention relates to novel substituted benzodithiophenes and benzodiselenophenes. The invention further relates to their use, especially as semiconductors or charge transport materials, in optical, electro-optical or electronic devices. The invention further relates to such devices comprising the novel materials.

### BACKGROUND AND PRIOR ART

Molecules based upon unsubstituted benzodithiophene and benzodiselenophene (1) have found use as organic thin film semiconductors (FIG. 1, Takimiya et al, JACS 2004, 126, p 5084).

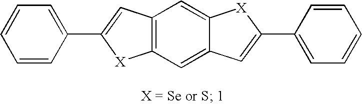

Compounds 1 have very poor solubility due to the lack of solublising substitutents on 1, and are purified by sublimation. Thin films of 1 for transistor application were also prepared by vacuum deposition. It is highly desirable to be able to form organic semiconductor thin films by solution processing, since this facilitates the development of low cost, large area deposition techniques. Takimiya do not describe a methodology for the attachment of aryl groups other than phenyl to the benzodithiophene core.

Thin films of 1 were analysed by x-ray diffraction and found to pack in a herringbone-type motif, with a combination of edge-to-face and face-to-face molecular interactions. The edge-to-face packing is expected to have poor molecular overlap, and may result in a reduction in charge carrier mobility for the material, since in organic materials charge moves by a hopping mechanism from one molecule to an adjacent molecule though interaction of the molecular orbitals.

Previously Anthony and co-workers have demonstrated a method for improving the packing of pentacene molecules (which also packs in a herring bone motif) by the introduction of bulky groups to the periphery of the molecule, which discourages edge-to-face packing and encourages the molecule to adopt a face-to-face packing motif (Adv. Mater 2003, 15, 2009). Anthony and co-workers have further adapted this approach to a range a pentacene-like molecules, some of which demonstrate good charge carrier mobility when fabricated from solution (JACS, 2005, 127, 4986). However substituted pentacenes exhibit poor photostability, both in solution and in the solid state, undergoing 4+4 dimerisations and photooxidations. (see Coppo & Yeates, Adv. Mater. 2005, p 3001; Maliakal et al, Chem. Mater. 2004, 16, 4980).

It was an aim of the present invention to provide new organic materials for use as semiconductors or charge transport materials, which are easy to synthesise, have high charge mobility and good processability. The materials should be easily processable to form thin and large-area films for use in semiconductor devices. In particular the materials should be oxidatively stable, but retain or even improve the desirable properties of the materials known form prior art. Another aim of the invention was to provide novel and improved benzodithiophene and benzodiselenophene derivatives that are more easily processible in the manufacture of semiconductor devices, are stable and allow easy synthesis also at large scale. EP 1 524 286 A1 discloses benzodithiophene compounds, but does not disclose compounds according to the present invention.

It was found that the above aims can be achieved by providing compounds according to the present invention.

### SUMMARY OF THE INVENTION

The invention relates to compounds of the following formula

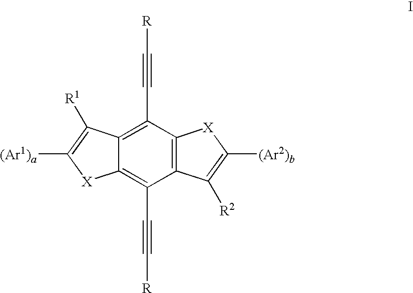

wherein
X is S or Se,
R is each occurrence independently of one another R³ or —SiR′R″R′″,
Ar¹ and Ar² are independently of each other an aryl or heteroaryl group that is optionally substituted with one or more groups R³, or denote —CX¹═CX²— or —C≡C—,
a and b are independently of each other 1, 2, 3, 4 or 5,
R¹, R² and R³ are independently of each other H, halogen or straight chain, branched or cyclic alkyl with 1 to 40 C-atoms, which may be unsubstituted, mono- or poly-substituted by F, Cl, Br, I or CN, it being also possible for one or more non-adjacent CH₂ groups to be replaced, in each case independently from one another, by —O—, —S—, —NH—, —NR⁰—, —SiR⁰R⁰⁰—, —CO—, —COO—, —OCO—, —OCO—O—, —S—CO—, —CO—S—, —CH═CH— or —C≡C— in such a manner that O and/or S atoms are not linked directly to one another, or optionally substituted aryl or heteroaryl, or P-Sp-,
P is a polymerisable or reactive group,
Sp is a spacer group or a single bond,
X¹ and X² are independently of each other are independently of each other H, F, Cl or CN,
R⁰ and R⁰⁰ are independently of each other H or alkyl with 1 to 12 C-atoms, and
R′, R″ and R′″ are identical or different groups selected from H, straight chain, branched or cyclic C₁-C₄₀-alkyl or C₁-C₄₀-alkoxy, C₆-C₄₀-aryl, C₆-C₄₀-arylalkyl, or C₆-C₄₀-arylalkyloxy, wherein all these groups are optionally substituted with one or more halogen atoms.

The invention further relates to a polymerisable mesogenic or liquid crystalline material comprising one or more compounds of formula I comprising at least one polymerisable group, and optionally comprising one or more further polymerisable compounds.

The invention further relates to an anisotropic polymer film obtainable from a polymerisable liquid crystalline material according to the present invention that is aligned in its liquid crystal phase into macroscopically uniform orientation and polymerised or crosslinked to fix the oriented state.

The invention further relates to the use of compounds of formula I as charge carrier materials and organic semiconductors.

The invention further relates to a formulation comprising one or more compounds of formula I, one or more solvents, and optionally one or more binders, preferably organic polymeric binders, or precursors thereof.

The invention further relates to a formulation comprising one or more compounds of formula I, one or more organic polymers or organic polymeric binders, or precursors thereof, and optionally one or more solvents.

The invention further relates to an organic semiconducting layer comprising a compound, material, polymer or formulation as described above and below.

The invention further relates to a process for preparing an organic semiconducting layer as described above and below, comprising the following steps
(i) depositing on a substrate a liquid layer of a formulation which comprises one or more compounds of formula I, one or more organic binders or precursors thereof and optionally one or more solvents,
(ii) forming from the liquid layer a solid layer which is the organic semiconducting layer,
(iii) optionally removing the layer from the substrate.

The invention further relates to the use of the compounds, materials, polymers, formulations and layers as described above and below in an electronic, optical or electrooptical component or device.

The invention further relates to an electronic, optical or electrooptical component or device comprising one or more compounds, materials, polymers, formulations or layers as described above and below.

Said electronic, optical or electrooptical component or device includes, without limitation, an organic field effect transistor (OFET), thin film transistor (TFT), component of integrated circuitry (IC), radio frequency identification (RFID) tag, organic light emitting diode (OLED), electroluminescent display, flat panel display, backlight, photodetector, sensor, logic circuit, memory element, capacitor, photovoltaic (PV) cell, charge injection layer, Schottky diode, planarising layer, antistatic film, conducting substrate or pattern, photoconductor, and electrophotographic element.

The invention further relates to a security marking or device comprising a FET or an RFID tag according to the invention.

### DETAILED DESCRIPTION OF THE INVENTION

The compounds according to the present invention are based on benzo[1,2-b:4,5-b′]dithiophene, hereinafter also shortly referred to as benzodithiophene or BDT, with the following structure (1)

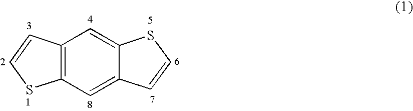

or benzo[1,2-b:4,5-b′]diselenophene, hereinafter also shortly referred to as benzodiselenophene or BDS, with a structure as shown above but where the S atoms are replaced by Se atoms.

The compounds according to the present invention exhibit good solubility and high charge carrier mobility when fabricated from solution. The incorporation of bulky substituents in the 4,8-positions of the BDT/BDS core affords soluble materials. An additional benefit of the introduction of bulky substituents is that the crystal packing of the materials is altered so that, edge-to-face interactions are disfavoured and face-to-face packing is favoured. Furthermore, the BDT/BDS core does not undergo photochemical dimerisations, and exhibits a much higher stability to photooxidation than pentacene derivatives.

Aromatic groups are readily incorporated into the 2,6-positions of the BDT/BDS core. This provides a facile route to tune the electronic properties of the molecule. By incorporating electron rich moieties such as thiophene or thieno[3,2-b]thiophene, the ionisation potential of the molecule can be reduced, whereas electron poor aromatics such as pyridine increase the ionisation potential of the molecule.

In formula I, R′, R″ and R′″ are preferably selected from C₁-C₄-alkyl, most preferably methyl, ethyl, n-propyl or isopropyl, or phenyl, wherein all these groups are optionally substituted for example with one or more halogen atoms. Preferably, R′, R″ and R′″ are each independently selected from optionally substituted C₁₋₁₀-alkyl, more preferably C₁₋₄-alkyl, most preferably C₁₋₃-alkyl, for example isopropyl, and optionally substituted C₆₋₁₀-aryl, preferably phenyl. Further preferred is a silyl group of formula —SiR′R″″ wherein R″″ forms a cyclic silylalkyl group together with the Si atom, preferably having 1 to 8 C atoms.

In one preferred embodiment of the silyl group, R′, R″ and R′″ are identical groups, for example identical, optionally substituted, alkyl groups, as in triisopropylsilyl. Very preferably the groups R′, R″ and R′″ are identical, optionally substituted C₁₋₁₀, more preferably C₁₋₄, most preferably C₁₋₃ alkyl groups. A preferred alkyl group in this case is isopropyl.

A silyl group of formula —SiR′R″R′″ or —SiR′R″″ as described above is a preferred optional substituent for the C₁-C₄₀-carbyl or hydrocarbyl group.

Preferred groups —SiR′R″R′″ include, without limitation, trimethylsilyl, triethylsilyl, tripropylsilyl, dimethylethylsilyl, diethylmethylsilyl, dimethylpropylsilyl, dimethylisopropylsilyl, dipropylmethylsilyl, diisopropylmethylsilyl, dipropylethylsilyl, diisopropylethylsilyl, diethylisopropylsilyl, triisopropylsilyl, trimethoxysilyl, triethoxysilyl, triphenylsilyl, diphenylisopropylsilyl, diisopropylphenylsilyl, diphenylethylsilyl, diethylphenylsilyl, diphenylmethylsilyl, triphenoxysilyl, dimethylmethoxysilyl, dimethylphenoxysilyl, methylmethoxyphenylsilyl, etc., wherein the alkyl, aryl or alkoxy group is optionally substituted.

In some cases it may be desirable to control the solubility of the semiconducting compounds of formula I in common organic solvents in order to make devices easier to fabricate. This may have advantages in making an FET for example, where solution coating, say, a dielectric onto the semiconducting layer may have a tendency to dissolve the semiconductor. Also, once a device is formed, a less soluble semiconductor may have less tendency to “bleed” across organic layers. In one embodiment of a way to control solubility of the semiconducting compounds of formula I above, the compounds comprise silyl groups —SiR′R″ R′″ wherein at least one of R′, R″ and R′″ contains an optionally substituted aryl, preferably phenyl, group. Thus, at least one of R′, R″ and R′″ may be an optionally substituted C₆₋₁₈ aryl, preferably phenyl, group, an optionally substituted C₆₋₁₈ aryloxy, preferably phenoxy, group, an optionally substituted C₆₋₂₀ arylalkyl, for example benzyl, group, or an optionally substituted C₆₋₂₀ arylalkyloxy, for example benzyloxy, group. In such cases, the remaining groups, if any, among R′, R″ and R′″ are preferably C₁₋₁₀, more preferably C₁₋₄ alkyl groups which are optionally substituted.

Further preferred are compounds of formula I wherein
X is S,
X is Se,
Ar¹ and/or Ar² is selected from phenyl, naphthalene-2-yl, pyridine-4-yl, thiophene-2-yl, selenophene-2-yl, biphenyl-1-yl, thieno[2,3b]thiophene-2-yl, benzo(b)thiophene-2-yl, all of which are optionally substituted, or —CH═CH— or —C≡C—,
(Ar¹)ₐ and (Ar²)_{b} are —CH═CH—Ar or —C≡C—Ar, with Ar being selected from phenyl, naphthalene-2-yl, pyridine-4-yl, thiophene-2-yl, selenophene-2-yl, biphenyl-1-yl thieno[2,3b]thiophene-2-yl, benzo(b)thiophene-2-yl, all of which are optionally substituted,
R¹, R² and R³ are selected from C₁-C₂₀-alkyl that is optionally substituted with one or more fluorine atoms, C₁-C₂₀-alkenyl, C₁-C₂₀-alkynyl, C₁-C₂₀-thioalkyl, C₁-C₂₀-silyl, C₁-C₂₀-ester, C₁-C₂₀-amino, C₁-C₂₀-fluoroalkyl, and optionally substituted aryl or heteroaryl, very preferably C₁-C₂₀-alkyl or C₁-C₂₀-fluoroalkyl,
one or both of R¹ and R² denote H,
R is alkyl or cycloalkyl,
R is —SiR′R″R′″,
a=b=1,
a=b=2,
a=b=3,
Ar¹ and Ar² are substituted by one or more groups R³,
Ar¹ and Ar² are substituted by at least one, preferably one group R³ that denotes P-Sp-.

If one of Ar¹ and Ar² is aryl or heteroaryl, it is preferably a mono-, bi- or tricyclic aromatic or heteroaromatic group with up to 25 C atoms, wherein the rings can be fused, and in which the heteroaromatic group contains at least one hetero ring atom, preferably selected from N, O and S. It is optionally substituted with one or more of F, Cl, Br, I, CN, and straight chain, branched or cyclic alkyl having 1 to 20 C atoms, which is unsubstituted, mono- or poly-substituted by F, Cl, Br, I, —CN or —OH, and in which one or more non-adjacent CH₂ groups are optionally replaced, in each case independently from one another, by —O—, —S—, —NH—, —NR⁰—, —SiR⁰R⁰⁰—, —CO—, —COO—, OCO—, —OCO—O, —S—CO—, —CO—S—, —CH≡CH— or —C≡C— in such a manner that O and/or S atoms are not linked directly to one another.

Preferred aryl and heteroaryl groups are selected from phenyl in which, in addition, one or more CH groups may be replaced by N, or naphthalene, alkyl fluorene or oxazole, wherein all these groups are optionally mono- or polysubstituted with L, wherein L is F, Cl, Br, or an alkyl, alkoxy, alkylcarbonyl, alkylcarbonyloxy or alkoxycarbonyl group with 1 to 12 C atoms, wherein one or more H atoms are optionally replaced by F or Cl. Further preferred groups are pyridine, naphthalene, thiophene, selenophene, thienothiophene and dithienothiophene which are substituted by one or more halogen, in particular fluorine, atoms.

Especially preferred aryl and heteroaryl groups are phenyl, fluorinated phenyl, pyridine, pyrimidine, biphenyl, naphthalene, fluorinated thiophene, selenophene, benzo[1,2-b:4,5-b′]dithiophene, thieno[3,2-b]thiophene, thiazole and oxazole, all of which are unsubstituted, mono- or polysubstituted with L as defined above.

If R¹, R² or R³ is an alkyl or alkoxy radical, i.e. where the terminal CH₂ group is replaced by —O—, this may be straight-chain or branched. It is preferably straight-chain, has 2 to 8 carbon atoms and accordingly is preferably ethyl, propyl, butyl, pentyl, hexyl, heptyl, octyl, ethoxy, propoxy, butoxy, pentoxy, hexyloxy, heptoxy, or octoxy, furthermore methyl, nonyl, decyl, undecyl, dodecyl, tridecyl, tetradecyl, pentadecyl, nonoxy, decoxy, undecoxy, dodecoxy, tridecoxy or tetradecoxy, for example.

Further preferred groups R¹⁻³ are cyclic alkyl groups like cyclohexyl, adamanthyl and bicyclo[2.2.2]octane.

Fluoroalkyl or fluorinated alkyl or alkoxy is preferably straight chain (O)CᵢF₂ᵢ₊₁, wherein i is an integer from 1 to 20, in particular from 1 to 15, very preferably (O)CF₃, (O)C₂F₅, (O)C₃F₇, (O)C₄F₉, (O)C₅F₁₁, (O)C₆F₁₃, (O)C₇F₁₅ or (O)C₈F₁₇, most preferably (O)C₆F₁₃.

CX¹═CX² is preferably —CH═CH—, —CH═CF—, —CF═CH—, —CF═CF—, —CH═C(CN)— or —C(CN)═CH—.

Halogen is preferably F, Br, Cl or I.

Hetero atoms are preferably selected from N, O and S.

The polymerisable or reactive group P is preferably selected from CH₂═CW¹—COO—,

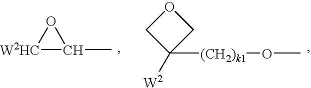

CH₂═CW²—(O)ₖ₁—, CH₃—CH═CH—O—, (CH₂═CH)₂CH—OCO—, (CH₂═CH)₂CH—O—, (CH₂═CH—CH₂)₂CH—OCO—, (CH₂═CH—CH₂)₂N—, HO—CW²W³—, HS—CW²W³—, HW²N—, HO—CW²W³—NH—, CH₂═CW¹—CO—NH—, CH₂═CH—(COO)ₖ₁-Phe-(O)ₖ₂—, Phe-CH═CH—, HOOC—, OCN—, and W⁴W⁵W⁶Si—, with W¹ being H, Cl, CN, phenyl or alkyl with 1 to 5 C-atoms, in particular H, Cl or CH₃, W² and W³ being independently of each other H or alkyl with 1 to 5 C-atoms, in particular methyl, ethyl or n-propyl, W⁴, W⁵ and W⁶ being independently of each other Cl, oxaalkyl or oxacarbonylalkyl with 1 to 5 C-atoms, Phe being 1,4-phenylene and k₁ and k₂ being independently of each other 0 or 1.

Especially preferred groups P are CH₂═CH—COO—, CH₂═C(CH₃)—COO—, CH₂═CH—, CH₂═C—-O—, (CH₂═CH)₂CH—OCO—, (CH₂═CH)₂CH—O—, and

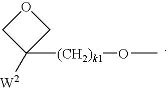

Very preferred are acrylate and oxetane groups. Oxetanes produce less shrinkage upon polymerisation (cross-linking), which results in less stress development within films, leading to higher retention of ordering and fewer defects Oxetane cross-linking also requires cationic initiator, which unlike free radical initiator is inert to oxygen.

As for the spacer group Sp all groups can be used that are known for this purpose to the skilled in the art. The spacer group Sp is preferably of formula Sp′-X, such that P-Sp- is P-Sp′-X—, wherein
Sp′ is alkylene with up to 20 C atoms which may be unsubstituted, mono- or poly-substituted by F, Cl, Br, I or CN, it being also possible for one or more non-adjacent CH₂ groups to be replaced, in each case independently from one another, by —O—, —S—, —NH—, —NR⁰—, —SiR⁰R⁰⁰—, —CO—, —COO—, —OCO—, —OCO—O—, —S—CO—, —CO—S—, —CH═CH— or —C≡C— in such a manner that O and/or S atoms are not linked directly to one another,
X is —O—, —S—, —CO—, —COO—, —OCO—, —O—COO—, —CO—NR⁰—, —NR⁰—CO—, —OCH₂—, —CH₂O—, —SCH₂—, —CH₂S—, —CF₂O—, —OCF₂—, —CF₂S—, —SCF₂—, —CF₂CH₂—, —CH₂CF₂—, —CF₂CF₂—, —CH═N—, —N═CH—, —N═N—, —CH═CR⁰—, —CX¹═CX²—, —C≡C—, —CH═CH—COO—, —OCO—CH═CH— or a single bond, and

R⁰, R⁰⁰, X¹ and X² have one of the meanings given above.

X is preferably —O—, —S—, —OCH₂—, —CH₂—, —SCH₂—, —CH₂S—, —CF₂O—, —OCF₂—, —CF₂S—, —SCF₂—, —CH₂CH₂—, —CF₂CH₂—, —CH₂CF₂—, —CF₂CF₂—, —CH═N—, —N═CH—, —N═N—, —CH═CR⁰—, —CX¹═CX²—, —C≡C— or a single bond, in particular —O—, —S—, —C≡C—, —CX¹═CX²— or a single bond, very preferably a group that is able to from a conjugated system, such as —C≡C— or —CX¹═CX²—, or a single bond.

Typical groups Sp′ are, for example, —(CH₂)ₚ—, —(CH₂CH₂O)_{q}—CH₂CH₂—, —CH₂CH₂—S—CH₂CH₂— or —CH₂CH₂—NH—CH₂CH₂— or —(SiR⁰R⁰⁰—O)ₚ—, with p being an integer from 2 to 12, q being an integer from 1 to 3 and R⁰ and R⁰⁰ having the meanings given above.

Preferred groups Sp′ are ethylene, propylene, butylene, pentylene, hexylene, heptylene, octylene, nonylene, decylene, undecylene, dodecylene, octadecylene, ethyleneoxyethylene, methyleneoxybutylene, ethylene-thioethylene, ethylene-N-methyl-iminoethylene, 1-methylalkylene, ethenylene, propenylene and butenylene for example.

Further preferred are compounds with one or two groups P-Sp- wherein Sp is a single bond.

In case of compounds with two groups P-Sp, each of the two polymerisable groups P and the two spacer groups Sp can be identical or different.

SCLCPs obtained from the inventive compounds or mixtures by polymerisation or copolymerisation have a backbone that is formed by the polymerisable group P.

Especially preferred are compounds of the following subformulae

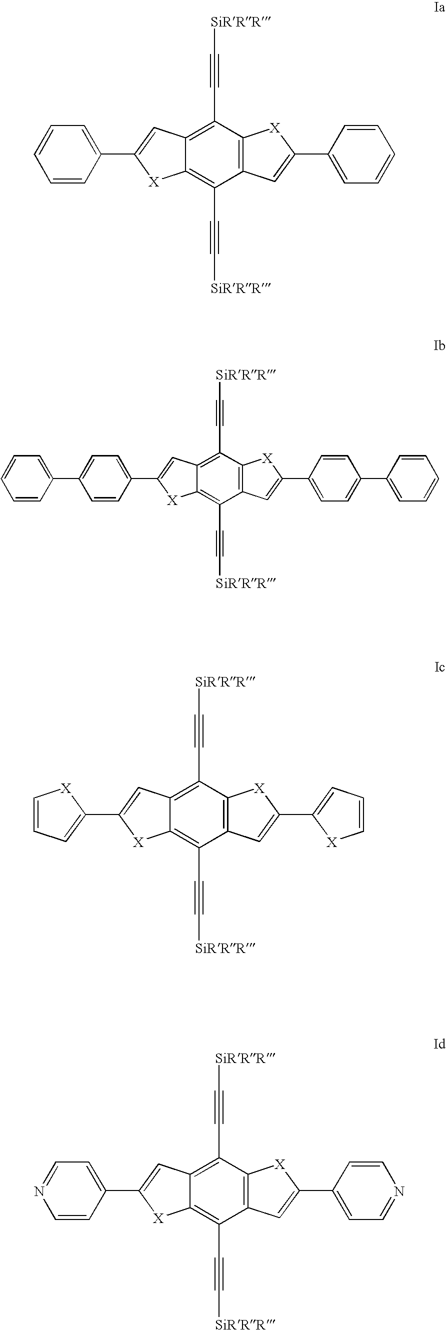

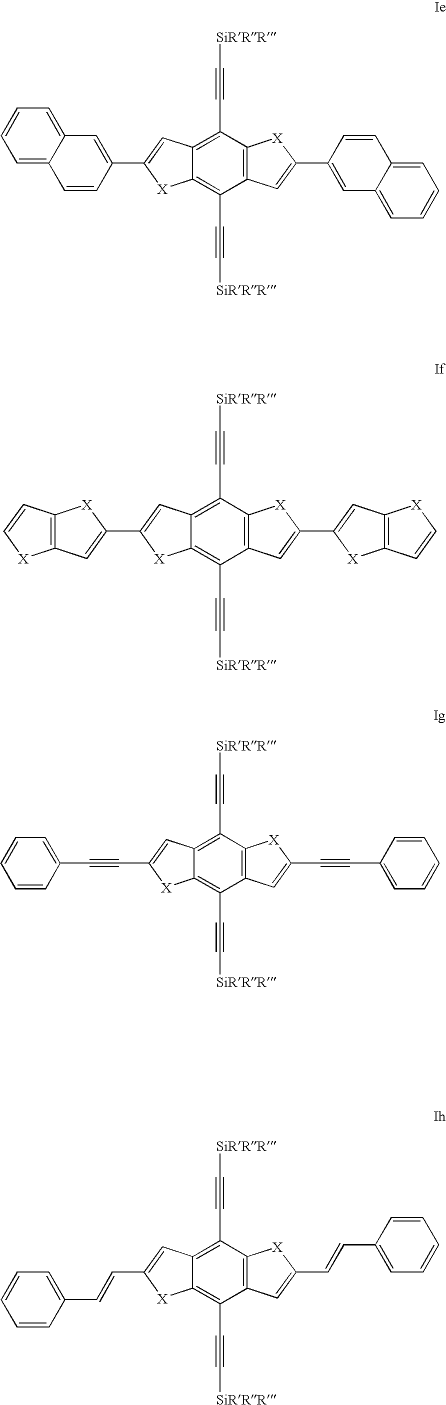

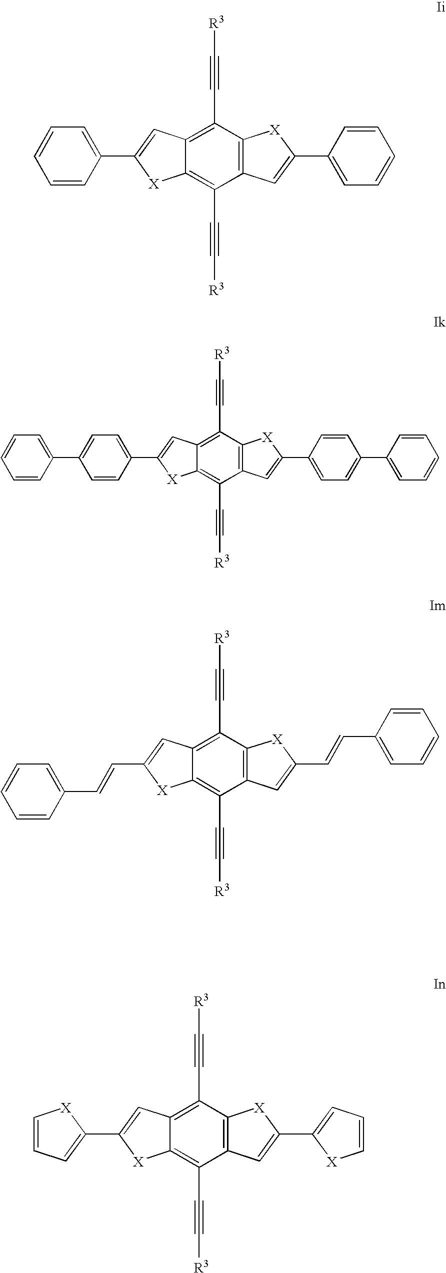

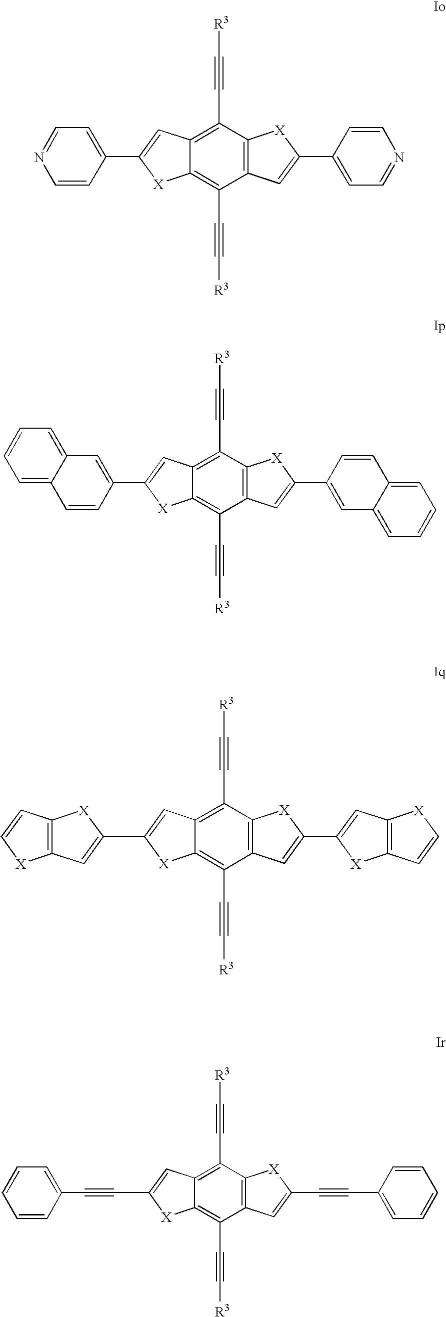

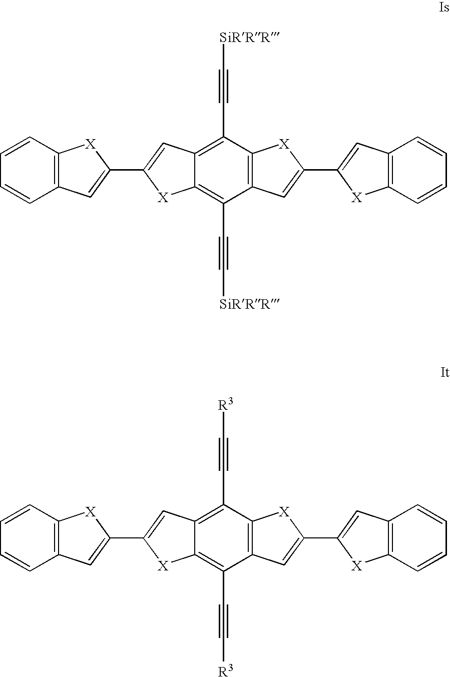

wherein X, R³, R′, R″ and R′″ have the meanings given above, and wherein the benzene rings and the thiophene rings are optionally substituted with one or more groups R³ as defined above. Especially preferred are compounds wherein X is S.

The compounds of the present invention can be synthesized according to or in analogy to known methods. Some preferred methods are described below.

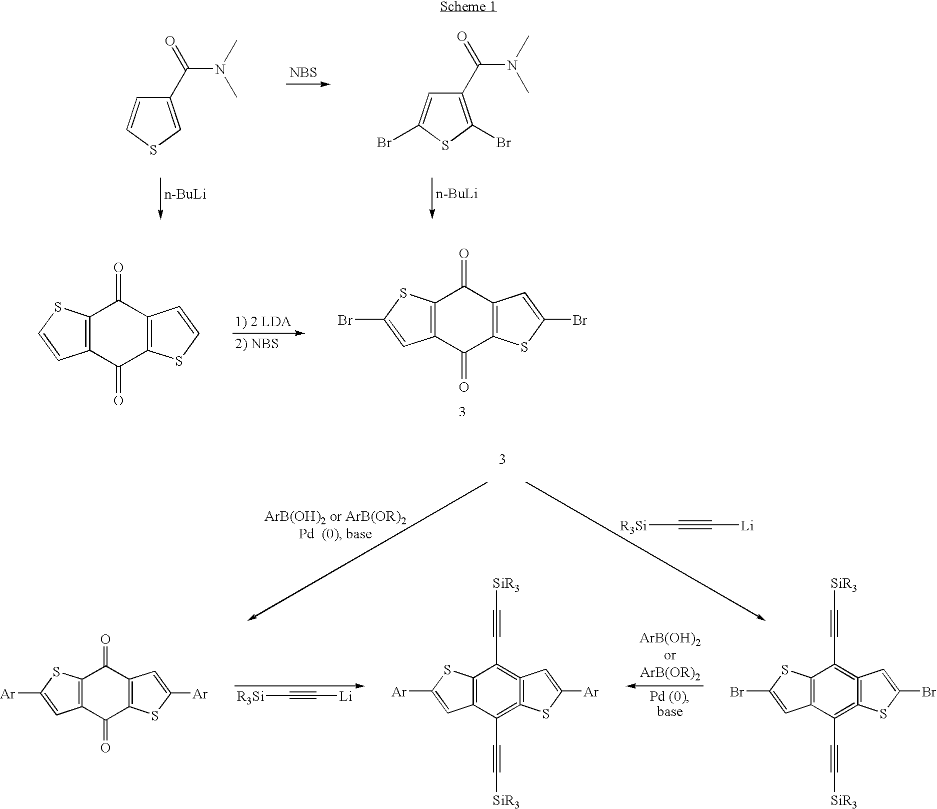

The synthesis of the compounds is outlined in scheme 1. The key intermediate is the 2,6-dibromo-4,8-dehydrobenzo[1,2-b:4,5-b′]dithiophene-4,8-dione (3), which can be readily reacted at the 4,8 positions by reaction with alkyl, alkenyl or alkynyl organomagnesium or organolithium reagents followed by reduction of the resulting diol intermediate, to introduce alkyl, alkenyl or alkynyl groups into the 4,8 positions. Intermediate (3) is either synthesised from the starting 4,8-dehydrobenzo[1,2-b:4,5-b′]dithiophene-4,8-dione (Slocum and Gierer, J. Org. Chem. 1974, 3668), by a double lithiation with a hindered amine base such as LDA (lithium diisopropylamide) followed by reaction with an electrophillic source of bromine. Or alternatively from 2,6-dibromo-4,8-dehydrobenzo[1,2-b:4,5-b′]dithiophene-4,8-dione directly by the reaction of 2,5-dibromo-3-thiophene carboxylic acid dimethyl amide with an organolithium reagent (in analogy to the method reported by Slocum and Gierer, J. Org. Chem. 1974, 3668). After introduction of the solubilising groups as described above, aryl groups can be introduced into the 2,6 position readily by standard Suzuki, Stille or Negishi coupling of bromo groups with an aryl boronic acid or ester, an aryl organotin reagent, or an aryl organozinc reagent, respectively. The selenophene derivatives of formula I are synthesized in analogy to the thiophenes.

The above methods of preparing the compounds of formula I are another aspect of the present invention.

The compounds are preferably synthesized by either

1a) reacting 2,5-dibromo-3-thiophene carboxylic dialkyl amide or 2,-5-dibromo-3-selenophene carboxylic dialkyl amide with an organolithium or organomagnesium reagent to generate in situ the 2-thiophene or 2-selenophene organolithium or organomagnesium reagent which undergoes self-condensation with another equivalent of thiophene or selenophene to afford 2,6-dibromo-4,8-dehydrobenzo[1,2-b:4,5-b′]dithiophene-4,8-dione, or 2,6-dibromo-4,8-dehydrobenzo[1,2-b;4,5-b′]diselenophene-4,8-dione.

or

1b) reacting 4,8-dehydrobenzo[1,2-b:4,5-b′]dithiophene-4,8-dione, or 4,8-dehydrobenzo[1,2-b:4,5-b′]diselenophene-4,8-dione, with two equivalents of a with a hindered lithium amide base, followed by reaction with an electrophillic source of bromine.

b) introducing aryl or heteroaryl groups in the 2,6 positions of the product of step a1) or a2) by standard Suzuki, Stille, Negishi or Kumada coupling with an aryl boronic acid or ester, an aryl organotin reagent, an aryl organozinc reagent or an organomagnesium reagent, respectively, in the presence of a suitable palladium or nickel catalyst

and

c) introducing an alkynyl group into the product of step b) by reacting it with an excess of the appropriate alkyl, alkenyl or alkenyl organolithium or organomagnesium reagent followed by reduction of the resulting diol intermediate

or

b1) introducing an alkynyl group into the product of step a1) or a2) by reacting it with an excess of the appropriate alkyl, alkenyl or alkenyl organolithium or organomagnesium reagent followed by reduction of the resulting diol interemediate

and

c1) introducing aryl or heteroaryl groups into the product of step b1 by standard Suzuki, Still, Negishi or Kumade coupling with an aryl boronic acid or ester, an aryl organotin reagent, an organozinc reagent or an organomagnesium reagent respectively, in the presence of a suitable palladium or nickel catalyst.

or

d) introducing alkenyl or alkynyl aryl or heteroaryl groups into the product of steps a1) or a2) by standard Heck, Sonogashira, or Suzuki coupling with an aryl alkene group, an aryl alkyne group or an aryl alkenyl boronic acid or esters respectively in the presence of a suitable palladium or nickel catalyst

A further aspect of the invention relates to both the oxidised and reduced form of the compounds and materials according to this invention. Either loss or gain of electrons results in formation of a highly delocalised ionic form, which is of high conductivity. This can occur on exposure to common dopants. Suitable dopants and methods of doping are known to those skilled in the art, e.g., from EP 0 528 662, U.S. Pat. No. 5,198,153 or WO 96/21659.

The doping process typically implies treatment of the semiconductor material with an oxidating or reducing agent in a redox reaction to form delocalised ionic centres in the material, with the corresponding counterions derived from the applied dopants. Suitable doping methods comprise for example exposure to a doping vapor in the atmospheric pressure or at a reduced pressure, electrochemical doping in a solution containing a dopant, bringing a dopant into contact with the semiconductor material to be thermally diffused, and ion-implantantion of the dopant into the semiconductor material.

When electrons are used as carriers, suitable dopants are for example halogens (e.g., I₂, Cl₂, Br₂, ICl, ICl₃, IBr and IF), Lewis acids (e.g., PF₅, AsF₅, SbF₅, BF₃, BCl₃, SbCl₅, BBr₃ and SO₃), protonic acids, organic acids, or amino acids (e.g., HF, HCl, HNO₃, H₂SO₄, HClO₄, FSO₃H and ClSO₃H), transition metal compounds (e.g., FeCl₃, FeOCl, Fe(ClO₄)₃, Fe(4-CH₃C₆H₄SO₃)₃, TiCl₄, ZrCl₄, HfCl₄, NbF₅, NbCl₅, TaCl₅, MoF₅, MoCl₅, WF₅, WCl₆, UF₆ and LnCl₃ (wherein Ln is a lanthanoid), anions (e.g., Cl⁻, Br⁻, I⁻, I₃⁻, HSO₄⁻, SO₄²⁻, NO₃⁻, ClO₄⁻, BF₄⁻, PF₆⁻, AsF₆⁻, SbF₆⁻, FeCl₄⁻, Fe(CN)₆³⁻, and anions of various sulfonic acids, such as aryl-SO₃⁻). When holes are used as carriers, examples of dopants are cations (e.g., H⁺, Li⁺, Na⁺, K⁺, Rb⁺and Cs⁺), alkali metals (e.g., Li, Na, K, Rb, and Cs), alkaline-earth metals (e.g., Ca, Sr, and Ba), O₂, XeOF₄, (NO₂⁺) (SbF₆⁻), (NO₂⁺) (SbCl₆⁻), (NO₂⁺) (BF₄⁻), AgClO₄, H₂IrCl₆, La(NO₃)₃.6H₂O, FSO₂OOSO₂F, Eu, acetylcholine, R₄N⁺, (R is an alkyl group), R₄P⁺ (R is an alkyl group), R₆As⁺ (R is an alkyl group), and R₃S⁺ (R is an alkyl group).

The conducting form of the compounds and materials of the present invention can be used as an organic “metal” in applications, for example, but not limited to, charge injection layers and ITO planarising layers in organic light emitting diode applications, films for flat panel displays and touch screens, antistatic films, printed conductive substrates, patterns or tracts in electronic applications such as printed circuit boards and condensers.

A preferred embodiment of the present invention relates to compounds of formula I and its preferred subformulae that are mesogenic or liquid crystalline, and very preferably comprise one or more polymerisable groups. Very preferred materials of this type are compounds formula I and its preferred subformulae wherein one or more of R¹, R² and/or R³ denote P-Sp-.

These materials are particularly useful as semiconductors or charge transport materials, as they can be aligned into uniform highly ordered orientation in their liquid crystal phase by known techniques, thus exhibiting a higher degree of order that leads to particularly high charge carrier mobility. The highly ordered liquid crystal state can be fixed by in situ polymerisation or crosslinking via the groups P to yield polymer films with high charge carrier mobility and high thermal, mechanical and chemical stability.

It is also possible to copolymerise the polymerisable compounds according to the present invention with other polymerisable mesogenic or liquid crystal monomers that are known from prior art, in order to induce or enhance liquid crystal phase behaviour.

Thus, another aspect of the invention relates to a polymerisable liquid crystal material comprising one or more compounds of the present invention as described above and below comprising at least one polymerisable group, and optionally comprising one or more further polymerisable compounds, wherein at least one of the polymerisable compounds of the present invention and/or the further polymerisable compounds is mesogenic or liquid crystalline.

Particularly preferred are liquid crystal materials having a nematic and/or smectic phase. For FET applications smectic materials are especially preferred. For OLED applications nematic or smectic materials are especially preferred.

Another aspect of the present invention relates to an anisotropic polymer film with charge transport properties obtainable from a polymerisable liquid crystal material as defined above that is aligned in its liquid crystal phase into macroscopically uniform orientation and polymerised or crosslinked to fix the oriented state.

Preferably polymerisation is carried out as in-situ polymerisation of a coated layer of the material, preferably during fabrication of the electronic or optical device comprising the inventive semiconductor material. In case of liquid crystal materials, these are preferably aligned in their liquid crystal state into homeotropic orientation prior to polymerisation, where the conjugated pi-electron systems are orthogonal to the direction of charge transport. This ensures that the intermolecular distances are minimised and hence then energy required to transport charge between molecules is minimised. The molecules are then polymerised or crosslinked to fix the uniform orientation of the liquid crystal state. Alignment and curing are carried out in the liquid crystal phase or mesophase of the material. This technique is known in the art and is generally described for example in D. J. Broer, et al., Angew. Makromol. Chem. 183, (1990), 45-66

Alignment of the liquid crystal material can be achieved for example by treatment of the substrate onto which the material is coated, by shearing the material during or after coating, by application of a magnetic or electric field to the coated material, or by the addition of surface-active compounds to the liquid crystal material. Reviews of alignment techniques are given for example by I. Sage in “Thermotropic Liquid Crystals”, edited by G. W. Gray, John Wiley & Sons, 1987, pages 75-77, and by T. Uchida and H. Seki in “Liquid Crystals—Applications and Uses Vol. 3”, edited by B. Bahadur, World Scientific Publishing, Singapore 1992, pages 1-63. A review of alignment materials and techniques is given by J. Cognard, Mol. Cryst. Liq. Cryst. 78, Supplement 1 (1981), pages 1-77.

Polymerisation can be achieved by exposure to heat or actinic radiation. Actinic radiation means irradiation with light, like UV light, IR light or visible light, irradiation with X-rays or gamma rays or irradiation with high energy particles, such as ions or electrons. Preferably polymerisation is carried out by UV irradiation at a non-absorbing wavelength. As a source for actinic radiation for example a single UV lamp or a set of UV lamps can be used. When using a high lamp power the curing time can be reduced. Another possible source for actinic radiation is a laser, like e.g. a UV laser, an IR laser or a visible laser.

Polymerisation is preferably carried out in the presence of an initiator absorbing at the wavelength of the actinic radiation. For example, when polymerising by means of UV light, a photoinitiator can be used that decomposes under UV irradiation to produce free radicals or ions that start the polymerisation reaction. When curing polymerisable materials with acrylate or methacrylate groups, preferably a radical photoinitiator is used, when curing polymerisable materials with vinyl, epoxide and oxetane groups, preferably a cationic photoinitiator is used. It is also possible to use a polymerisation initiator that decomposes when heated to produce free radicals or ions that start the polymerisation. As a photoinitiator for radical polymerisation for example the commercially available Irgacure 651, Irgacure 184, Darocure 1173 or Darocure 4205 (all from Ciba Geigy A G) can be used, whereas in case of cationic photopolymerisation the commercially available UVI 6974 (Union Carbide) can be used.

The polymerisable material can additionally comprise one or more other suitable components such as, for example, catalysts, sensitizers, stabilizers, inhibitors, chain-transfer agents, co-reacting monomers, surface-active compounds, lubricating agents, wetting agents, dispersing agents, hydrophobing agents, adhesive agents, flow improvers, defoaming agents, deaerators, diluents, reactive diluents, auxiliaries, colourants, dyes or pigments.

Compounds comprising one or more groups P-Sp- can also be copolymerised with polymerisable mesogenic compounds to induce or enhance liquid crystal phase behaviour. Polymerisable mesogenic compounds that are suitable as comonomers are known in prior art and disclosed for example in WO 93/22397; EP 0,261,712; DE 195,04,224; WO 95/22586 and WO 97/00600.

Another aspect of the invention relates to a liquid crystal side chain polymer (SCLCP) obtained from a polymerisable liquid crystal material as defined above by polymerisation or polymeranaloguous reaction. Particularly preferred are SCLCPs obtained from one or more compounds formula I and its preferred subformulae wherein one or more of R¹⁻³, preferably one or two groups R³, are a polymerisable or reactive group, or from a polymerisable mixture comprising one or more of said monomers.

Another aspect of the invention relates to an SCLCP obtained from one or more polymerisable compounds of formula I and its preferred subformulae, or from a polymerisable liquid crystal mixture as defined above, by copolymerisation or polymeranaloguous reaction together with one or more additional mesogenic or non-mesogenic comonomers.

Side chain liquid crystal polymers or copolymers (SCLCPs), in which the semiconducting component is located as a pendant group, separated from a flexible backbone by an aliphatic spacer group, offer the possibility to obtain a highly ordered lamellar like morphology. This structure consists of closely packed conjugated aromatic mesogens, in which very close (typically <4 Å) pi-pi stacking can occur. This stacking allows intermolecular charge transport to occur more easily, leading to high charge carrier mobilities. SCLCPs are advantageous for specific applications as they can be readily synthesized before processing and then e.g. be processed from solution in an organic solvent. If SCLCPs are used in solutions, they can orient spontaneously when coated onto an appropriate surface and when at their mesophase temperature, which can result in large area, highly ordered domains.

SCLCPs can be prepared from the polymerisable compounds or mixtures according to the invention by the methods described above, or by conventional polymerisation techniques which are known to those skilled in the art, including for example radicalic, anionic or cationic chain polymerisation, polyaddition or polycondensation. Polymerisation can be carried out for example as polymerisation in solution, without the need of coating and prior alignment, or polymerisation in situ. It is also possible to form SCLCPs by grafting compounds according to the invention with a suitable reactive group, or mixtures thereof, to presynthesized isotropic or anisotropic polymer backbones in a polymeranaloguous reaction. For example, compounds with a terminal hydroxy group can be attached to polymer backbones with lateral carboxylic acid or ester groups, compounds with terminal isocyanate groups can be added to backbones with free hydroxy groups, compounds with terminal vinyl or vinyloxy groups can be added, e.g., to polysiloxane backbones with Si—H groups. It is also possible to form SCLCPs by copolymerisation or polymeranaloguous reaction from the inventive compounds together with conventional mesogenic or non mesogenic comonomers. Suitable comonomers are known to those skilled in the art. In principle it is possible to use all conventional comonomers known in the art that carry a reactive or polymerisable group capable of undergoing the desired polymer-forming reaction, like for example a polymerisable or reactive group P as defined above. Typical mesogenic comonomers are for example those mentioned in WO 93/22397, EP 0 261 712, DE 195 04 224, WO 95/22586, WO 97/00600 and GB 2 351 734. Typical non mesogenic comonomers are for example alkyl acrylates or alkyl methacrylates with alkyl groups of 1 to 20 C atoms, like methyl acrylate or methyl methacrylate.

The compounds according to the present invention show advantageous solubility properties which allow production processes using solutions of these compounds. Thus films, including layers and coatings, may be generated by low cost production techniques, e.g., spin coating. Suitable solvents or solvent mixtures comprise alkanes and/ or aromatics, especially their fluorinated derivatives.

The compounds of the present invention are useful as optical, electronic and semiconductor materials, in particular as charge transport materials in field effect transistors (FETs), e.g., as components of integrated circuitry, ID tags or TFT applications. Alternatively, they may be used in organic light emitting diodes (OLEDs) in electroluminescent display applications or as backlight of, e.g., liquid crystal displays, as photovoltaics or sensor materials, for electrophotographic recording, and for other semiconductor applications.

FETs where an organic semiconductive material is arranged as a film between a gate-dielectric and a drain and a source electrode, are generally known, e.g., from U.S. Pat. No. 5,892,244, WO 00/79617, U.S. Pat. No. 5,998,804, and from the references cited in the background and prior art chapter and listed below. Due to the advantages, like low cost production using the solubility properties of the compounds according to the invention and thus the processibility of large surfaces, preferred applications of these FETs are such as integrated circuitry, TFT-displays and security applications.

In security applications, field effect transistors and other devices with semiconductive materials, like transistors or diodes, may be used for ID tags or security markings to authenticate and prevent counterfeiting of documents of value like banknotes, credit cards or ID cards, national ID documents, licenses or any product with monetry value, like stamps, tickets, shares, cheques etc..

Alternatively, the compounds according to the invention may be used in organic light emitting devices or diodes (OLEDs), e.g., in display applications or as backlight of e.g. liquid crystal displays. Common OLEDs are realized using multilayer structures. An emission layer is generally sandwiched between one or more electron-transport and/or hole-transport layers. By applying an electric voltage electrons and holes as charge carriers move towards the emission layer where their recombination leads to the excitation and hence luminescence of the lumophor units contained in the emission layer. The inventive compounds, materials and films may be employed in one or more of the charge transport layers and/or in the emission layer, corresponding to their electrical and/or optical properties.

Furthermore their use within the emission layer is especially advantageous, if the compounds, materials and films according to the invention show electroluminescent properties themselves or comprise electroluminescent groups or compounds. The selection, characterization as well as the processing of suitable monomeric, oligomeric and polymeric compounds or materials for the use in OLEDs is generally known by a person skilled in the art, see, e.g., Meerholz, Synthetic Materials, 111-112, 2000, 31-34, Alcala, J. Appl. Phys., 88, 2000, 7124-7128 and the literature cited therein.

According to another use, the inventive compounds, materials or films, especially those which show photoluminescent properties, may be employed as materials of light sources, e.g., of display devices such as described in EP 0 889 350 A1 or by C. Weder et al., Science, 279, 1998, 835-837.

The compounds of formula I can also be combined with an organic binder resin (hereinafter also referred to as “the binder”) with little or no reduction of their charge mobility, even an increase in some instances. For instance, the compound of formula I may be dissolved in a binder resin (for example poly(α-methylstyrene) and deposited (for example by spin coating), to form an organic semiconducting layer yielding a high charge mobility.

The invention also provides an organic semiconducting layer which comprises the organic semiconducting layer formulation.

The invention further provides a process for preparing an organic semiconducting layer, said process comprising the following steps:
(i) depositing on a substrate a liquid layer of a formulation comprising one or more compounds of formula I as described above and below, one or more organic binder resins or precursors thereof, and optionally one or more solvents,
(ii) forming from the liquid layer a solid layer which is the organic semiconducting layer,
(iii) optionally removing the layer from the substrate.

The process is described in more detail below.

The invention additionally provides an electronic device comprising the said organic semiconducting layer. The electronic device may include, without limitation, an organic field effect transistor (OFET), organic light emitting diode (OLED), photodetector, sensor, logic circuit, memory element, capacitor or photovoltaic (PV) cell. For example, the active semiconductor channel between the drain and source in an OFET may comprise the layer of the invention. As another example, a charge (hole or electron) injection or transport layer in an OLED device may comprise the layer of the invention. The formulations according to the present invention and layers formed therefrom have particular utility in OFETs especially in relation to the preferred embodiments described herein.

In a preferred embodiment of the present invention the semiconducting compound of formula I has a charge carrier mobility, μ, of more than 10⁻⁵ cm²V⁻¹s⁻¹, preferably more than 10⁻⁴ cm²V⁻¹s⁻¹, in particular more than 10⁻³ cm²V⁻¹s⁻¹, very preferably more than 10⁻² cm²V⁻¹s⁻¹ and most preferably more than 10⁻¹ cm²V⁻¹ s⁻¹.

The formulation according to the present invention may be a blend comprising one or more oligomeric polyacene(s) of formula I and further comprising one or more polymers or polymeric binders, preferably synthetic organic polymer(s), like for example thermoplastic polymers, thermosetting polymers, duromers, elastomers, conductive polymers, engineering plastics etc.. The polymer may also be a copolymer.

Examples of a thermoplastic polymer include a polyolefin such as polyethylene, polypropylene, polycycloolefin, ethylene-propylene copolymer, etc., polyvinyl chloride, polyvinylidene chloride, polyvinyl acetate, polyacrylic acid, polymethacrylic acid, polystyrene, polyamide, polyester, polycarbonate, etc. Examples of a thermosetting polymer include a phenol resin, a urea resin, a melamine resin, an alkyd resin, an unsaturated polyester resin, an epoxy resin, a silicone resin, a polyurethane resin, etc. Examples of an engineering plastic include polyimide,polyphenylene oxide, polysulfone, etc. The synthetic organic polymer can also be a synthetic rubber such as styrene-butadiene, etc., or a fluoro resin such as polytetrafluoroethylene, etc. The conductive polymers include conjugated polymers such as polyacetylene, polypyrrole, polyallylenevinylene, polythienylenevinylene, etc. and those in which electron-donating molecules or electron-accepting molecules are doped.

The binder is typically a polymer and may comprise either an insulating binder or a semiconducting binder, or mixtures thereof. These are referred to herein as ‘the organic binder’, ‘the polymeric binder’ or simply ‘the binder’.

Preferred binders according to the present invention are materials of low permittivity, that is, those having a permittivity ε at 1,000 Hz of 3.3 or less. The organic binder preferably has a permittivity ε at 1,000 Hz of 3.0 or less, more preferably 2.9 or less. Preferably the organic binder has a permittivity ε at 1,000 Hz of 1.7 or more. It is especially preferred that the permittivity of the binder is in the range from 2.0 to 2.9. Whilst not wishing to be bound by any particular theory it is believed that the use of binders with a permittivity ε of greater than 3.3 at 1,000 Hz, may lead to a reduction in the OSC layer mobility in an electronic device, for example an OFET. In addition, high permittivity binders could also result in increased current hysteresis of the device, which is undesirable.

An example of a suitable organic binder is polystyrene. Further examples are given below.

In one type of preferred embodiment, the organic binder is one in which at least 95%, more preferably at least 98% and especially all of the atoms consist of hydrogen, fluorine and carbon atoms.

It is preferred that the binder normally contains conjugated bonds, especially conjugated double bonds and/or aromatic rings.

The binder should preferably be capable of forming a film, more preferably a flexible film. Polymers of styrene and α-methyl styrene, for example copolymers including styrene, α-methylstyrene and butadiene may suitably be used.

Binders of low permittivity of use in the present invention have few permanent dipoles which could otherwise lead to random fluctuations in molecular site energies. The permittivity ε (dielectric constant) can be determined by the ASTM D150 test method.

It is also preferred that in the present invention binders are used which have solubility parameters with low polar and hydrogen bonding contributions as materials of this type have low permanent dipoles. A preferred range for the solubility parameters (‘Hansen parameter’) of a binder for use in accordance with the present invention is provided in Table 1 below.

TABLE 1

| | Hansen parameter | | |
|---|---|---|---|
| | δ_{d} MPa^{1/2} | δₚ MPa^{1/2} | δₕ MPa^{1/2} |
| Preferred range | 14.5+ | 0-10 | 0-14 |
| More preferred range | 16+ | 0-9 | 0-12 |
| Most preferred range | 17+ | 0-8 | 0-10 |

The three dimensional solubility parameters listed above include: dispersive (δ_{d}), polar (δₚ) and hydrogen bonding (δₕ) components (C. M. Hansen, Ind. Eng. and Chem., Prod. Res. and Devl., 9, No 3, p 282., 1970). These parameters may be determined empirically or calculated from known molar group contributions as described in Handbook of Solubility Parameters and Other Cohesion Parameters ed. A. F. M. Barton, CRC Press, 1991. The solubility parameters of many known polymers are also listed in this publication.

It is desirable that the permittivity of the binder has little dependence on frequency. This is typical of non-polar materials. Polymers and/or copolymers can be chosen as the binder by the permittivity of their substituent groups. A list of suitable and preferred low polarity binders is given (without limiting to these examples) in Table 2:

TABLE 2

| | typical low |
|---|---|
| | frequency |
| Binder | permittivity (ε) |
| polystyrene | 2.5 |
| poly(α-methylstyrene) | 2.6 |
| poly(α-vinylnaphtalene) | 2.6 |
| poly(vinyltoluene) | 2.6 |
| polyethylene | 2.2-2.3 |
| cis-polybutadiene | 2.0 |
| polypropylene | 2.2 |
| polyisoprene | 2.3 |
| poly(4-methyl-1-pentene) | 2.1 |
| poly (4-methylstyrene) | 2.7 |
| poly(chorotrifluoroethylene) | 2.3-2.8 |
| poly(2-methyl-1,3-butadiene) | 2.4 |
| poly(p-xylylene) | 2.6 |
| poly(α-α-α′-α′ tetrafluoro-p-xylylene) | 2.4 |
| poly[1,1-(2-methyl propane)bis(4- | 2.3 |
| phenyl)carbonate] | |
| poly(cyclohexyl methacrylate) | 2.5 |
| poly(chlorostyrene) | 2.6 |
| poly(2,6-dimethyl-1,4-phenylene ether) | 2.6 |
| olyisobutylene | 2.2 |
| poly(vinyl cyclohexane) | 2.2 |
| poly(vinylcinnamate) | 2.9 |
| poly(4-vinylbiphenyl) | 2.7 |

Other polymers suitable as binders include poly(1,3-butadiene) or polyphenylene.

Especially preferred are formulations wherein the binder is selected from poly-α-methyl styrene, polystyrene and polytriarylamine or any copolymers of these, and the solvent is selected from xylene(s), toluene, tetralin and cyclohexanone.

Copolymers containing the repeat units of the above polymers are also suitable as binders. Copolymers offer the possibility of improving compatibility with the polyacene of formula I, modifying the morphology and/or the glass transition temperature of the final layer composition. It will be appreciated that in the above table certain materials are insoluble in commonly used solvents for preparing the layer. In these cases analogues can be used as copolymers. Some examples of copolymers are given in Table 3 (without limiting to these examples). Both random or block copolymers can be used. It is also possible to add some more polar monomer components as long as the overall composition remains low in polarity.

TABLE 3

| | typical low |
|---|---|
| | frequency |
| Binder | permittivity (ε) |
| poly(ethylene/tetrafluoroethylene) | 2.6 |
| poly(ethylene/chlorotrifluoroethylene) | 2.3 |
| fluorinated ethylene/propylene copolymer | 2-2.5 |
| polystyrene-co-α-methylstyrene | 2.5-2.6 |
| ethylene/ethyl acrylate copolymer | 2.8 |
| poly(styrene/10% butadiene) | 2.6 |
| poly(styrene/15% butadiene) | 2.6 |
| poly(styrene/2,4 dimethylstyrene) | 2.5 |
| Topas ™ (all grades) | 2.2-2.3 |

Other copolymers may include: branched or non-branched polystyrene-block-polybutadiene, polystyrene-block(polyethylene-ran-butylene)-block-polystyrene, polystyrene-block-polybutadiene-block-polystyrene, polystyrene-(ethylene-propylene)-diblock-copolymers (e.g. KRATON®-G1701E, Shell), poly(propylene-co-ethylene) and poly(styrene-co-methylmethacrylate).

Preferred insulating binders for use in the organic semiconductor layer formulation according to the present invention are poly(α-methylstyrene), polyvinylcinnamate, poly(4-vinylbiphenyl), poly(4-methylstyrene), and Topas™ 8007 (linear olefin, cyclo-olefin(norbornene) copolymer available from Ticona, Germany). Most preferred insulating binders are poly(α-methylstyrene), polyvinylcinnamate and poly(4-vinylbiphenyl).

The binder can also be selected from crosslinkable binders, like e.g. acrylates, epoxies, vinylethers, thiolenes etc., preferably having a sufficiently low permittivity, very preferably of 3.3 or less. The binder can also be mesogenic or liquid crystalline.

It is also possible that the organic binder itself is a semiconductor, in which case it will be referred to herein as a semiconducting binder. The semiconducting binder is still preferably a binder of low permittivity as herein defined. Semiconducting binders for use in the present invention preferably have a number average molecular weight (Mₙ) of at least 1500-2000, more preferably at least 3000, even more preferably at least 4000 and most preferably at least 5000. The semiconducting binder preferably has a charge carrier mobility, μ, of at least 10⁻⁵ cm²V⁻¹s⁻¹, more preferably at least 10⁻⁴ cm²V⁻¹s⁻¹.

Suitable and preferred semiconducting binders include, without limitation, arylamine polymers as described in WO 99/32537 A1 and WO 00/78843 A1, semiconducting polymers as described in WO 2004/057688 A1, fluorene-arylamine copolymers as described in WO 99/54385 A1, indenofluorene polymers as described in WO 2004/041901 A1, Macromolecules 2000, 33(6), 2016-2020 and Advanced Materials, 2001, 13, 1096-1099, polysilane polymers as described by Dohmara et al., Phil. Mag. B. 1995, 71, 1069, polythiophenes as described in WO 2004/057688 A1, and polyarylamine-butadiene copolymers as described in JP 2005-101493 A1.

Generally, suitable and preferred binders are selected from polymers containing substantially conjugated repeat units, for example homopolymers or copolymers (including block copolymers) of the general formula II

A_{(c)}B_{(d)} . . . Z_{(z)} II

wherein A, B, . . . , Z in random polymers each represent a monomer unit and in block polymers each represent a block, and (c), (d), . . . (z) each represent the mole fraction of the respective monomer unit in the polymer, that is each (c), (d), . . . (z) is a value from 0 to 1 and the total of (c)+(d)+ . . . +(z)=1.

Examples of suitable and preferred monomer units or blocks A, B, . . . Z include those of formulae 1 to 8 given below. Therein m is as defined in formula 1a and, if >1, may also indicate a block unit instead of a single monomer unit.

1. Triarylamine units, preferably units of formula 1a (as disclosed in U.S. Pat. No. 6,630,566) or 1b

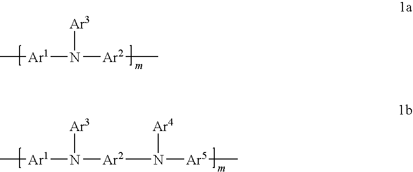

wherein
Ar¹⁻⁵ which may be the same or different, denote, independently if in different repeat units, an optionally substituted aromatic group that is mononuclear or polynuclear, and
m is 1 or an integer >1 preferably ≧10, more preferably ≧20.

In the context of Ar¹⁻⁵, a mononuclear aromatic group has only one aromatic ring, for example phenyl or phenylene. A polynuclear aromatic group has two or more aromatic rings which may be fused (for example napthyl or naphthylene), individually covalently linked (for example biphenyl) and/or a combination of both fused and individually linked aromatic rings. Preferably each of Ar¹⁻⁵ is an aromatic group which is substantially conjugated over substantially the whole group.

2. Fluorene units of formula 2

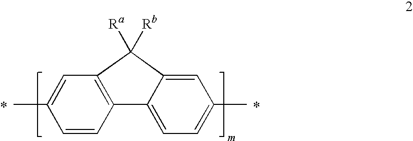

wherein
R^{a} and R^{b} are independently of each other selected from H, F, CN, NO₂, —N(R^{c})(R^{d}) or optionally substituted alkyl, alkoxy, thioalkyl, acyl, aryl,
R^{c} and R^{d} are independently or each other selected from H, optionally substituted alkyl, aryl, alkoxy or polyalkoxy or other substituents,
   and wherein the asterisk (*) is any terminal or end capping group including H, and the alkyl and aryl groups are optionally fluorinated

3. Heterocyclic units of formula 3

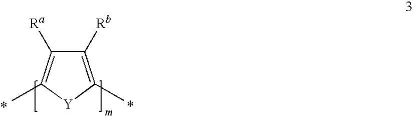

wherein
Y is Se, Te, O, S or —N(R^{e}), preferably O, S or —N(R^{e})—,
R^{e} is H, optionally substituted alkyl or aryl,
R^{a} and R^{b} are as defined in formula 2.

4. Units of formula 4

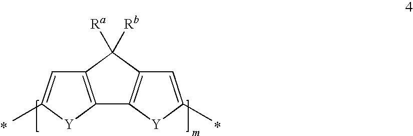

wherein R^{a}, R^{b} and Y are as defined in formulae 2 and 3.

5. Units of formula S

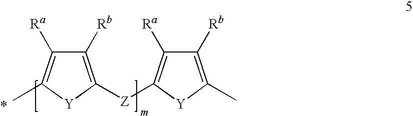

wherein R^{a}, R^{b} and Y are as defined in formulae 2 and 3,
z is —C(T¹)=C(T²)-, —C≡C—, —N(R^{f})—, —N═N—, (R^{f})═N—, —N═C(R^{f})—,
T¹ and T² independently of each other denote H, Cl, F, —CN or lower alkyl with 1 to 8 C atoms,
R^{f} is H or optionally substituted alkyl or aryl.

6. Spirobifluorene units of formula 6

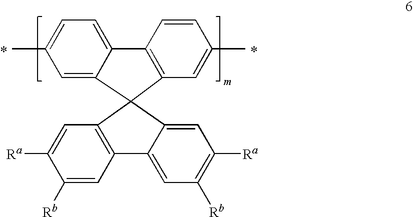

wherein R^{a} and R^{b} are as defined in formula 2.

7. Indenofluorene units of formula 7

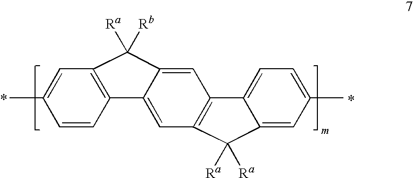

wherein R^{a} and R^{b} are as defined in formula 2.

8. Thieno[2,3-b]thiophene units of formula 8

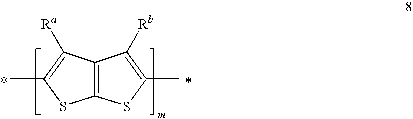

wherein R^{a} and R^{b} are as defined in formula 2.

9. Thieno[3,2-b]thiophene units of formula 9

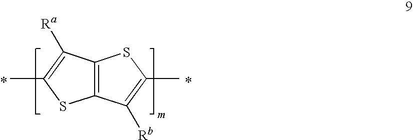

wherein R^{a} and R^{b} are as defined in formula 2.

In the case of the polymeric formulae described herein, such as formulae 1 to 9, the polymers may be terminated by any terminal group, that is any end-capping or leaving group, including H.

In the case of block copolymers, each monomer A, B, . . . Z may be a conjugated oligomer or polymer comprising a number m, for example 2 to 50, of the units of formulae 1-9.

Especially preferred semiconducting binders are PTAA and its copolymers, fluorene polymers and their copolymers with PTM, polysilanes, in particular polyphenyltrimethyidisilane, and cis- and trans-indenofluorene polymers and their copolymers with PTAA having alkyl or aromatic substitution, in particular polymers of the following formulae:

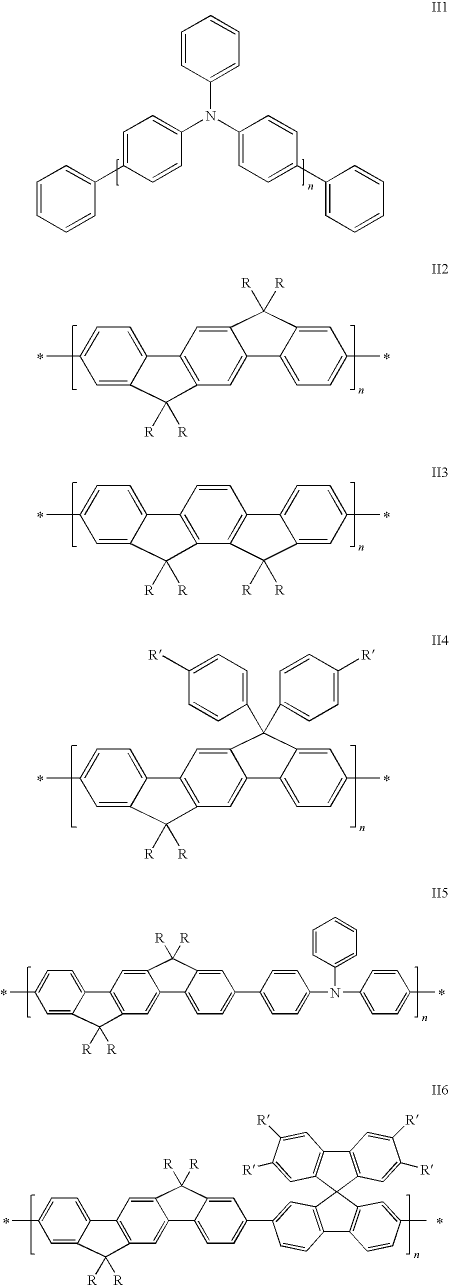

wherein
R has one of the meanings of R^{a} of formula 2, and preferably is straight-chain or branched alkyl or alkoxy with 1 to 20, preferably 1 to 12 C atoms, or aryl with 5 to 12 C atoms, preferably phenyl, that is optionally substituted,
R′ has one of the meanings of R, and
n is an integer >1.

Examples of typical and preferred polymers include, without limitation, the polymers listed below:

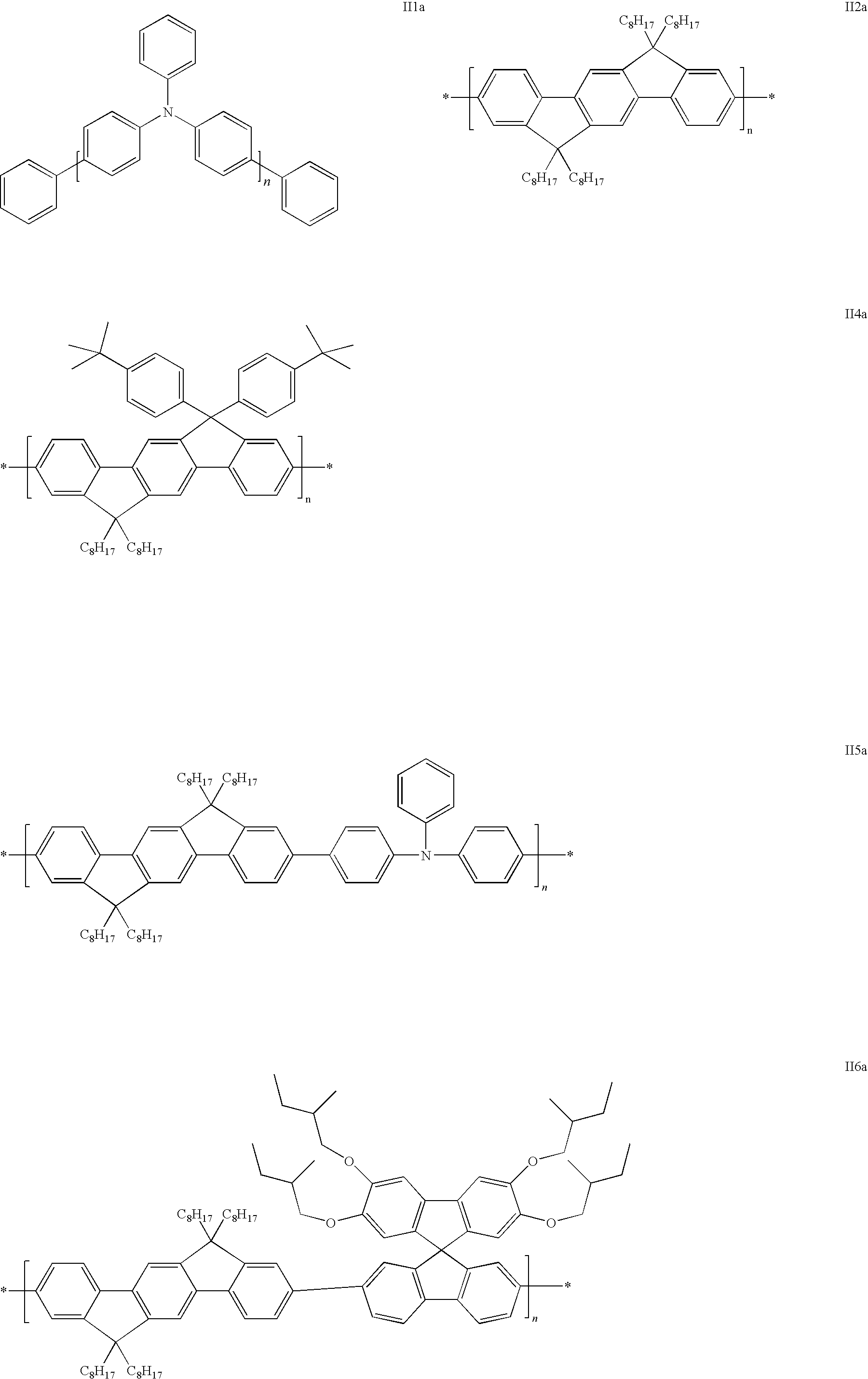

Preferably the semiconducting binder has a charge carrier mobility ≧10⁻³ cm²V⁻¹s⁻¹, more preferably ≧5×10⁻³ cm²V⁻¹s⁻¹, most preferably ≧10⁻² cm²V⁻¹s⁻¹, and preferably ≦1 cm²V^{31 1}s⁻¹. Preferably the binder has an ionisation potential close to that of the crystalline small molecule OSC, most preferably within a range of ±0.6 eV, even more preferably ±0.4 eV of the ionisation potential of the samII molecule OSC. The molecular weight of the binder polymer is preferably between 1000 and 10⁷ more preferably 10,000 and 10⁶, most preferably 20,000 and 500,000. Polyphenylene vinylene (PPV) polymers are less preferred, because they offer little or no benefit due to their low charge carrier mobility (typically <10⁻⁴ cm²V⁻¹s⁻¹). Similarly polyvinylcarbazole (PVK) is generally an effective binder, but is less preferred in the current invention because, due to its low mobility, it polymer is less efficient in improving contacts for short channel devices. Generally it is desirable that a polymer having a high charge carrier mobility is used as binder in the present invention. The semiconducting polymer is also preferably of low polarity, the permittivity being in the same range as defined above for insulating binders.

In order to adjust the rheological properties of the semiconducting binder/OSC small molecule composition, a small amount of inert binder may also be added. Suitable inert binders are described for example in WO 02/45184 A1. The inert binder content is preferably between 0.1% to 10% of the solid weight of the total composition after drying.

Selection of the most appropriate binder and formulation of the optimum binder to semiconductor ratio allows the morphology of the semiconducting layer to be controlled. Experiments have shown that morphologies ranging from amorphous through to crystalline can be obtained by variation of formulation parameters such as binder resin, solvent, concentration, deposition method, etc.

Important factors for the binder resin are as follows: the binder normally contains conjugated bonds and/or aromatic rings, the binder should preferably be capable of forming a flexible film, the binder should be soluble in commonly used solvents, the binder should have a suitable glass transition temperature and the permittivity of the binder should have little dependence on frequency.

For application of the semiconducting layer in p-channel FETs, it is desirable that the semiconducting binder should have a similar or higher ionisation potential than the OSC, otherwise the binder may form hole traps. In n-channel materials the semiconducting binder should have a similar or lower electron affinity than the n-type semiconductor to avoid electron trapping.

The formulation and the OSC layer according to the present invention may be prepared by a process which comprises:
(i) first mixing the OSC compound(s) and binder(s) or precursors thereof. Preferably the mixing comprises mixing the components together in a solvent or solvent mixture,
(ii) applying the solvent(s) containing the OSC compound(s) and binder(s) to a substrate; and optionally evaporating the solvent(s) to form a solid OSC layer according to the present invention,
(iii) and optionally removing the solid OSC layer from the substrate or the substrate from the solid layer.

In step (i) the solvent may be a single solvent, or the OSC compound(s) and the binder(s) may each be dissolved in a separate solvent followed by mixing the two resultant solutions to mix the compounds.

The binder may be formed in situ by mixing or dissolving the OSC compound(s) in a precursor of a binder, for example a liquid monomer, oligomer or crosslinkable polymer, optionally in the presence of a solvent, and depositing the mixture or solution, for example by dipping, spraying, painting or printing it, on a substrate to form a liquid layer and then curing the liquid monomer, oligomer or crosslinkable polymer, for example by exposure to radiation, heat or electron beams, to produce a solid layer. If a preformed binder is used it may be dissolved together with the compound of formula I in a suitable solvent, and the solution deposited for example by dipping, spraying, painting or printing it on a substrate to form a liquid layer and then removing the solvent to leave a solid layer. It will be appreciated that solvents are chosen which are able to dissolve both the binder and the OSC compound(s), and which upon evaporation from the solution blend give a coherent defect free layer.

Suitable solvents for the binder or the OSC compound can be determined by preparing a contour diagram for the material as described in ASTM Method D 3132 at the concentration at which the mixture will be employed. The material is added to a wide variety of solvents as described in the ASTM method.

A formulation according to the present invention may also comprise two or more OSC compounds and/or two or more binders or binder precursors, and the process described above may also be applied to such a formulation.

Examples of suitable and preferred organic solvents include, without limitation, dichloromethane, trichloromethane, monochlorobenzene, o-dichlorobenzene, tetrahydrofuran, anisole, morpholine, toluene, o-xylene, m-xylene, p-xylene, 1,4-dioxane, acetone, methylethylketone, 1,2-dichloroethane, 1,1,1-trichloroethane, 1,1,2,2-tetrachloroethane, ethyl acetate, n-butyl acetate, dimethylformamide, dimethylacetamide, dimethylsulfoxide, tetralin, decalin, indane and/or mixtures thereof.

After the appropriate mixing and ageing, solutions are evaluated as one of the following categories: complete solution, borderline solution or insoluble. The contour line is drawn to outline the solubility parameter-hydrogen bonding limits dividing solubility and insolubility. ‘Complete’ solvents falling within the solubility area can be chosen from literature values such as published in “Crowley, J. D., league, G. S. Jr and Lowe, J. W. Jr., Journal of Paint Technology, 38, No 496, 296 (1966)”. Solvent blends may also be used and can be identified as described in “Solvents, W. H. Ellis, Federation of Societies for Coatings Technology, p 9-10, 1986”. Such a procedure may lead to a blend of ‘non’ solvents that will dissolve both the binder and the compound of formula 1, although it is desirable to have at least one true solvent in a blend.

Especially preferred solvents for use in the formulation according to the present invention, with semiconducting binders and mixtures thereof, are xylene(s), toluene, tetralin, chlorobenzene and o-dichlorobenzene.

The ratio of the OSC compound(s) to the binder in a formulation or layer according to the present invention is typically from 20:1 to 1:20 by weight, for example 1:1 by weight. In a preferred embodiment, the ratio of OSC compound(s) to binder is 10:1 or more, preferably 15:1 or more by weight. Ratios of up to 18:1 or 19:1 have also proven to be suitable.

In accordance with the present invention it has further been found that the level of the solids content in the organic semiconducting layer formulation is also a factor in achieving improved mobility values for electronic devices such as OFETs. The solids content of the formulation is commonly expressed as follows:

$$Solids content ( \% ) = \frac{a + b}{a + b + c} \times 100$$

wherein

a=mass of compound of formula I, b=mass of binder and c=mass of solvent.

The solids content of the formulation is preferably 0.1 to 10% by weight, more preferably 0.5 to 5% by weight.

It is desirable to generate small structures in modern microelectronics to reduce cost (more devices/unit area), and power consumption. Patterning of the layer of the invention may be carried out by photolithography or electron beam lithography, laser patterning.

Liquid coating of organic electronic devices such as field effect transistors is more desirable than vacuum deposition techniques. The formulations of the present invention enable the use of a number of liquid coating techniques. The organic semiconductor layer may be incorporated into the final device structure by, for example and without limitation, dip coating, spin coating, ink jet printing, letter-press printing, screen printing, doctor blade coating, roller printing, reverse-roller printing, offset lithography printing, flexographic printing, web printing, spray coating, brush coating or pad printing. The present invention is particularly suitable for use in spin coating the organic semiconductor layer into the final device structure.

Selected formulations of the present invention may be applied to prefabricated device substrates by ink jet printing or microdispensing. Preferably industrial piezoelectric print heads such as but not limited to those supplied by Aprion, Hitachi-Koki, InkJet Technology, On Target Technology, Picojet, Spectra, Trident, Xaar may be used to apply the organic semiconductor layer to a substrate. Additionally semi-industrial heads such as those manufactured by Brother, Epson, Konica, Seiko Instruments Toshiba TEC or single nozzle microdispensers such as those produced by Microdrop and Microfab may be used.

In order to be applied by ink jet printing or microdispensing, the mixture of the compound of formula I and the binder should be first dissolved in a suitable solvent. Solvents must fulfill the requirements stated above and must not have any detrimental effect on the chosen print head. Additionally, solvents should have boiling points >100° C., preferably >140° C. and more preferably >150° C. in order to prevent operability problems caused by the solution drying out inside the print head. Suitable solvents include substituted and non-substituted xylene derivatives, di-C₁₋₂-alkyl formamide, substituted and non-substituted anisoles and other phenol-ether derivatives, substituted heterocycles such as substituted pyridines, pyrazines, pyrimidines, pyrrolidinones, substituted and non-substituted N,N-di-C₁₋₂-alkylanilines and other fluorinated or chlorinated aromatics.

A preferred solvent for depositing a formulation according to the present invention by ink jet printing comprises a benzene derivative which has a benzene ring substituted by one or more substituents wherein the total number of carbon atoms among the one or more substituents is at least three. For example, the benzene derivative may be substituted with a propyl group or three methyl groups, in either case there being at least three carbon atoms in total. Such a solvent enables an ink jet fluid to be formed comprising the solvent with the binder and the OSC compound which reduces or prevents clogging of the jets and separation of the components during spraying. The solvent(s) may include those selected from the following list of examples: dodecylbenzene, 1-methyl-4-tert-butylbenzene, terpineol limonene, isodurene, terpinolene, cymene, diethylbenzene. The solvent may be a solvent mixture, that is a combination of two or more solvents, each solvent preferably having a boiling point >100° C., more preferably >140° C. Such solvent(s) also enhance film formation in the layer deposited and reduce defects in the layer.

The ink jet fluid (that is mixture of solvent, binder and semiconducting compound) preferably has a viscosity at 20° C. of 1-100 mPa·s, more preferably 1-50 mPa·s and most preferably 1-30 mPa·s.

The use of the binder in the present invention also allows the viscosity of the coating solution to be tuned to meet the requirements of the particular print head.

The semiconducting layer of the present invention is typically at most 1 micron (=1 μm) thick, although it may be thicker if required. The exact thickness of the layer will depend, for example, upon the requirements of the electronic device in which the layer is used. For use in an OFET or OLED, the layer thickness may typically be 500 nm or less.

The substrate used for preparing the OSC layer may include any underlying device layer, electrode or separate substrate such as silicon wafer, glass or polymer substrate for example.

In a particular embodiment of the present invention, the binder may be alignable, for example capable of forming a liquid crystalline phase. In that case the binder may assist alignment of the OSC compound(s), for example such that its long molecular axis is preferentially aligned along the direction of charge transport. Suitable processes for aligning the binder include those processes used to align polymeric organic semiconductors and are described in prior art, for example in WO 03/007397.

A formulation according to the present invention can additionally comprise one or more further components like for example surface-active compounds, lubricating agents, wetting agents, dispersing agents, hydrophobing agents, adhesive agents, flow improvers, defoaming agents, deaerators, diluents, reactive or non-reactive diluents, auxiliaries, colourants, dyes, pigments or nanoparticles, furthermore, especially in case crosslinkable binders are used, catalysts, sensitizers, stabilizers, inhibitors, chain-transfer agents or co-reacting monomers.

The invention further relates to an electronic device comprising the OSC layer. The electronic device may include, without limitation, an organic field effect transistor (OFET), organic light emitting diode (OLED), photodetector, sensor, logic circuit, memory element, capacitor or photovoltaic (PV) cell. For example, the active semiconductor channel between the drain and source in an OFET may comprise the layer of the invention. As another example, a charge (hole or electron) injection or transport layer in an OLED device may comprise the layer of the invention. The OSC formulations according to the present invention and OSC layers formed therefrom have particular utility in OFETs especially in relation to the preferred embodiments described herein.

An OFET device according to the present invention preferably comprises:
a source electrode,
a drain electrode,
a gate electrode,
an OSC layer as described above,
one or more gate insulator layers,
optionally a substrate,

The gate, source and drain electrodes and the insulating and semiconducting layer in the OFET device may be arranged in any sequence, provided that the source and drain electrode are separated from the gate electrode by the insulating layer, the gate electrode and the semiconductor layer both contact the insulating layer, and the source electrode and the drain electrode both contact the semiconducting layer.

The OFET device can be a top gate device or a bottom gate device. Suitable structures and manufacturing methods of an OFET device are known to the skilled in the art and are described in the literature, for example in WO 03/052841.

The gate insulator layer preferably comprises a fluoropolymer, like e.g. the commercially available Cytop 809M® or Cytop 107M® (from Asahi Glass). Preferably the gate insulator layer is deposited, e.g. by spin-coating, doctor blading, wire bar coating, spray or dip coating or other known methods, from a formulation comprising an insulator material and one or more solvents with one or more fluoro atoms (fluorosolvents), preferably a perfluorosolvent. A suitable perfluorosolvent is e.g. FC75® (available from Acros, catalogue number 12380). Other suitable fluoropolymers and fluorosolvents are known in prior art, like for example the perfluoropolymers Teflon AF® 1600 or 2400 (from DuPont) or Fluoropel® (from Cytonix) or the perfluorosolvent FC 43® (Acros, No. 12377).

Unless the context clearly indicates otherwise, as used herein plural forms of the terms herein are to be construed as including the singular form and vice versa.

Throughout the description and claims of this specification, the words “comprise” and “contain” and variations of the words, for example “comprising” and “comprises”, mean “including but not limited to”, and are not intended to (and do not) exclude other components.

It will be appreciated that variations to the foregoing embodiments of the invention can be made while still falling within the scope of the invention. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the invention are applicable to all aspects of the invention and may be used in any combination. Likewise, features described in non-essential combinations may be used separately (not in combination).

It will be appreciated that many of the features described above, particularly of the preferred embodiments, are inventive in their own right and not just as part of an embodiment of the present invention. Independent protection may be sought for these features in addition to or alternative to any invention presently claimed.

The invention will now be described in more detail by reference to the following examples, which are illustrative only and do not limit the scope of the invention.

### Example 1

Compound (1) is prepared as follows:

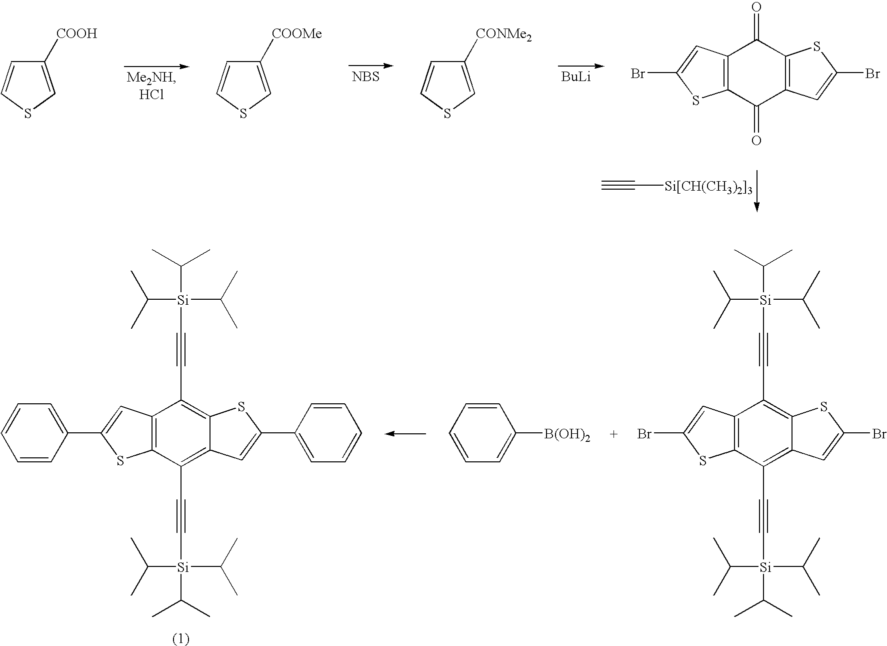

### Step 1-1: Thiophene-3-carboxylic acid dimethyl amide

3-Thiophenecarboxylic acid (20.0 g, 156.1 mmol) is dissolved in DCM (250 ml), followed by the addition of DMAP (0.5 g), N,N-dimethylamine hydrochloride (12.72 g, 156.1 mmol) and DCC (32.21 g, 156.1 mmol) with stirring at room temperature. After 10 min, triethylamine (50 ml) is added slowly. This resulting mixture is stirred overnight (15 h) at room temperature. The precipitate is filtered off and the filtrate evaporated under reduced pressure. The residue is purified by column chromatography, eluting with petrol/ethyl acetate (from 9:1 to 3:2), to give a pale yellow oil (19.71 g, 81%). ¹H NMR (300 Hz, CDCl₃): δ (ppm) 7.53 (dd, J=2.8, 1.1 Hz, 1 H, Ar—H), 7.72 (dd, J=5.1, 2.8 Hz, 1H, Ar—H), 7.23 (dd, J=5.1, 1.1 Hz, 1H, Ar—H), 3.09 (s, 6H, CH₃); ¹³C NMR (75 Hz, CDCl₃): δ (ppm) 167.0 (C═O), 136.8, 127.3, 126.5, 125.6.

### Step 1.2: 2,5-Dibromothiophene-3-carboxylic acid dimethyl amide

To a solution of thiophene-3-carboxylic acid dimethyl amide (6.26 g, 40.3 mmol) in DMF is added N-bromosuccinimide (15.95 g, 88.7 mmol) at room temperature. This mixture is stirred for 2 h in the absence of light, the poured into water (200 ml) and the product is extracted with ethyl acetate (3×100 ml). The organic layers are combined and washed with water (3×150 ml), brine (150 ml) then dried over sodium sulphate. The solvent is removed under reduced pressure. The residue is purified by column chromatography, eluting with petrol/ethyl acetate (9:1 to 4:1), to give a yellow oil (10.05 g, 80%). ¹H NMR (300 Hz, CDCl₃): δ (ppm) 6.92 (s, 1H, Ar—H), 3.10 (s, 3H, CH₃), 2.99 (s, 3H, CH₃); ¹³C NMR (75 Hz, CDCl₃): δ (ppm) 164.3 (C═O), 138.2, 129.6, 112.6, 109.7, 38.3, 35.0.

### Step 1.3: 2,6-Dibromo-1,5-dithia-s-indacene-4,8-dione

To a solution of 2,5-dibromothiophene-3-carboxylic acid dimethyl amide (8.03 g, 25.7 mmol) in anhydrous diethyl ether (70 ml) is added BuLi (2.5 M in hexanes, 10 ml, 25.0 mmol) dropwise at −78° C. under nitrogen, with stirring. After complete addition, the reaction mixture is allowed to warm to room temperature and stirred for another 1 h, then poured into saturated ammonium chloride solution. The precipitate is collected by filtration and washed with diethyl ether, to give a yellow solid, which is recrystallised with acetonitrile/THF to offer yellow crystals (2.79 g, 58%). ¹H NMR (300 Hz, CDCl₃): δ (ppm) 7.56 (2H, Ar—H); ¹³C NMR (75 Hz, CDCl₃): δ (ppm) 172.1 (C═O), 144.9, 142.5, 129.2, 123.6.

### Step 1.4: 2,6-Dibromo-4,8-bis[(triisopropylsilanyl)ethynyl]-1,5-dithia-s-indacene

To a solution of triisopropylsilylacetylene (1.77 g, 9.7 mmol) in 1,4-dioxane (150 ml) is added n-BuLi (1.60 M in hexanes, 5.5 ml, 8.8 mmol) dropwise at RT. This solution is stirred for 10 min, followed by the addition of 2,6-dibromo-1,5-dithia-s-indacene-4,8-dione (3.34 g, 8.8 mmol). The resulting mixture is heated at reflux overnight (˜15 h). After cooling, solid SnCl₂ (7.0 g), then conc. HCl solution (15 ml) is added, and the mixture stirred for 1 h. The precipitate is collected by filtration and washed with diethyl ethyl to give product as white solid (2.66 g, 42%). ¹H NMR (300 Hz, CDCl₃): δ (ppm) 7.52 (s, 2H, Ar—H), 1.21 (m, 42H, CH and CH₃); ¹³C NMR (75 Hz, CDCl₃): δ (ppm) 141.9, 137.8, 125.9, 117.6, 110.4, 103.1, 101.4, 18.8, 11.3.

### Step 1.5: 2,6-Diphenyl-4,8-bis[(triisopropylsilanyl)ethynyl]-1,5-dithia-s-indacene

To a 20-ml microwave reaction tube is charged 2,6-dibromo-4,8-bis[(triisopropylsilanyl)ethynyl]-1,5-dithia-s-indacene (0.43 g, 0.61 mmol), tetrakis(triphenylphosphine)palladium (0.05 g) and THF (10 ml), then phenylbronic acid (0.17 g, 1.39 mmol) and potassium carbonate solution (0.77 g, 9.2 mmol, in 3 ml water). This reaction mixture is degassed with nitrogen for 5 min, then heated in a microwave reactor (Personal Chemistry Creator) at 100° C. for 120 s, 120° C. for 120 s and 140° C. for 600 s. The mixture is poured into water, then extracted with ethyl acetate (3×50 ml). The combined organic layers are washed with water and brine, then dried over sodium sulphate. The solvent is removed under reduced pressure.

The residue is purified by column chromatography, eluting with petroleum/ethyl acetate (10:0 to 9:1), to give a yellow solid, which is recrystallised with petroleum ether (b.p. 80-100° C.), to afford yellow crystals (0.39 g, 91%). ¹H NMR (300 Hz, CDCl₃): δ (ppm) 7.80 (s, 2H, Ar—H), 7.76 (m, 4H, Ar—H), 7.47 (m, 4H, Ar—H), 7.38 (tt, 2H, J=7.3, 1.1 Hz, Ar—H), 1.26 (m, 42H, CH and CH₃); ¹³C NMR (75 Hz, CDCl₃): δ (ppm) 145.7, 140.5, 139.5, 134.1, 129.1, 128.7, 126.6, 118.6, 111.6, 102.5, 101.9, 18.8, 11.4.

### Example2

Compound (2), 2,6-Bisbenzo(b)thiophen-2-yl-4,8-bis[(triisopropyl-silanyl)ethynyl]-1,5-dithia-s-indacene, is prepared as follows:

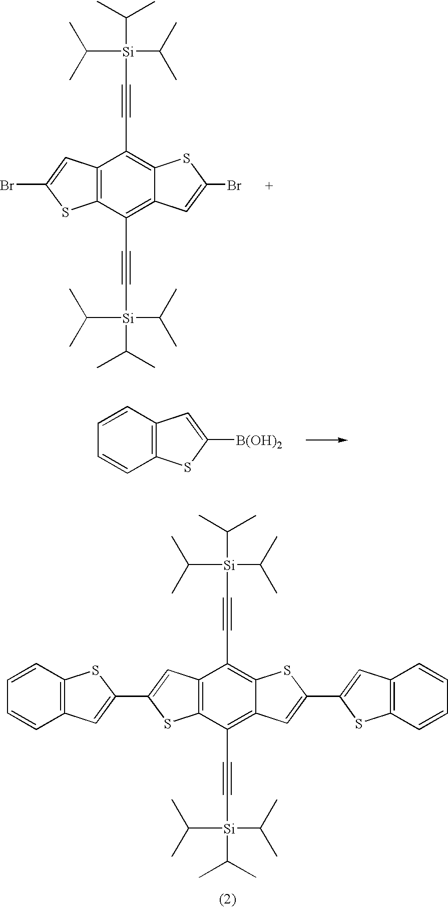

To a 20-ml microwave reaction tube is charged 2,6-dibromo-4,8-bis[(triisopropylsilanyl)ethynyl]-1,5-dithia-s-indacene (0.19 g, 0.27 mmol), tetrakis(triphenylphosphine)palladium (0.05 g) and THF (8 ml), then benzo(b)thiophene-2-boronic acid (0.15 g, 0.84 mmol) and potassium carbonate solution (0.9 g, 6.52 mmol, in 3 ml water). This reaction mixture is degassed with nitrogen for 5 min, then heated in microwave reactor (Personal Chemisty Creator) at 100° C. for 120 s, 120° C. for 120 s and 140° C. for 720 s. The mixture is poured into water and stirred for 10 min. The precipitate is collected by filtration and washed with water and diethyl ether, to give a yellow solid (0.18 g, 82%). ¹H NMR (300 Hz, CDCl₃): δ (ppm) 7.78-7.84 (m, 4H, Ar—H), 7.76 (s, 2H, Ar—H), 7.56 (s, 2H, Ar—H), 7.30-7.40 (m, 4H, Ar—H), 1.29 (m, 42H, CH and CH₃); ¹³C NMR (75 Hz, CDCl₃): δ (ppm) 146.3, 141.2, 140.6, 140.3, 139.9, 139.5, 139.0, 137.1, 125.2, 124.8, 123.9, 122.18, 122.15, 120.6, 111.7, 18.8, 11.5.

### Example 3

Compound (3), 2,6-Dithiophen-2-yl-4,8-bis[(triisopropyl-silanyl)ethynyl]-1,5-dithia-s-indacene, is prepared as follows:

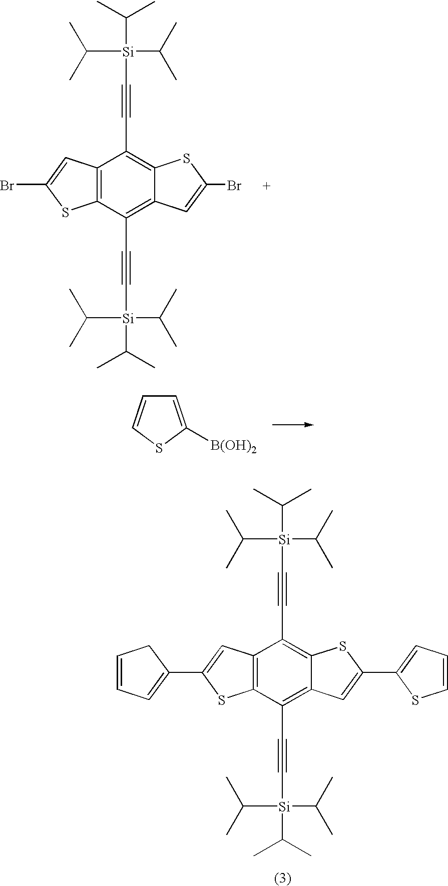

To a 20-ml reaction tube is charged with 2,6-Dibromo-4,8-bis[(triisopropylsilanyl)ethynyl]-1,5-dithia-s-indacene (0.25 g, 0.35 mmol), tetrakis(triphenylphosphine)palladium (0.05 g) and THF (10 ml), then thiophene-2-bronic acid (0.19 g, 1.48 mmol) and potassium carbonate solution (0.60 g, 4.4 mmol, in water 3 ml). This reaction mixture is degassed with nitrogen for 5 min, then heated in microwave reactor at 100° C. for 120 s, 120° C. for 120 s and 140° C. for 720 s. The mixture is poured into water then extracted with ethyl acetate (3×50 ml). The combined organic layers are washed with water and brine, then dried over sodium sulphate. The solvent is removed under reduced pressure. The residue is purified by column chromatography, eluting with petroleum/ethyl acetate (10:0 to 9:1), to give a yellow solid, which is recrystallised with petroleum (bp 80-100° C.), to afford yellow crystals (0.17 g, 68%). ¹H NMR (300 Hz, CDCl₃): δ (ppm) 7.63(s, 2H, Ar—H), 7.33 (m, 4H, Ar—H), 7.08 (m, 2H, Ar—H), 1.25 (m, 42H, CH and CH₃).

### Example 4

Compound (4) is prepared as follows:

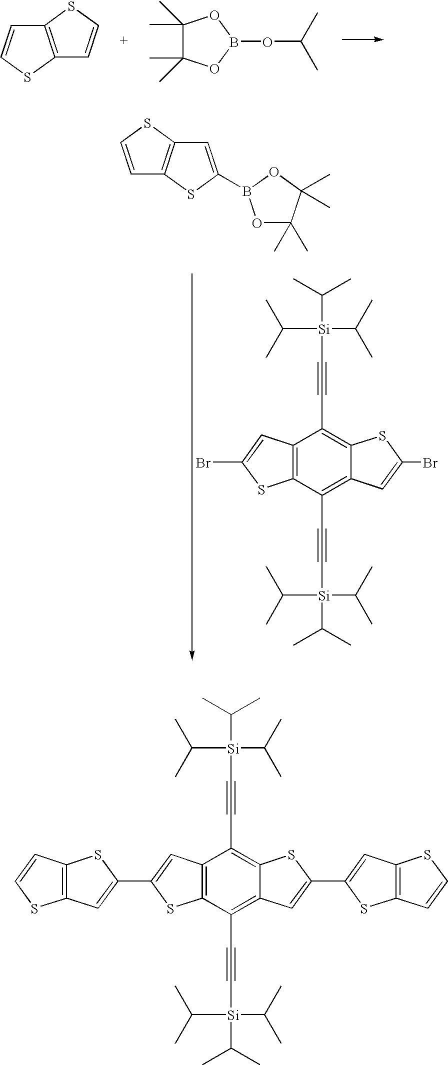

### Step 4.1: 4,4,5,5-tetramethyl-2-(thieno[3,2-b]thiophen-2-yl)-[1,3,2]-dioxaborolane

To a solution of thieno[3,2-b]thiophene (4.08 g, 29.1 mmol) in THF (70 ml) is added BuLi (2.5 M in hexanes, 10.5 ml, 26.3 mmol) at −78° C. dropwise, with stirring, under N₂. After complete addition, the mixture is stirred for 30 min at the same temperature, followed by the addition of 2-isopropoxy-4,4,5,5-tetramethyl-[1,3,2]dioxaborolane (4.89 g, 26.3 mmol). The mixture is allowed to warm to room temperature and stirred overnight (˜15 h), then poured to a sat.aq. ammonium chloride solution. The product is extracted with ethyl actate (3×70 ml). The extracts are combined and washed with brine, then dried (Na₂SO₄). The solvent is removed under reduced pressure the residue is recrystallised with acetonitrile, to give deep blue crystals (5.14 g, 73%). ¹H NMR (300 Hz, CDCl₃): δ (ppm) 7.76 (s, 1H, Ar—H), 7.42 (d, J=5.3 Hz, 1H, Ar—H), 7.21 (d, J=5.3 Hz, 1H, Ar—H), 1.32 (s, 12H, CH₃); ¹³C NMR (75 Hz, CDCl₃): δ (ppm) 145.7, 140.9, 130.2, 129.1, 119.5, 84.3, 24.8.

### Step 4.2: 2,6-bis(thieno[3,2-b]thiophen-2-yl)-4,8-bis[(triisopropylsilanyl)-ethynyl]-1,5-dithia-s-indacene

To a 20-ml microwave reaction tube is charged 2,6-dibromo-4,8-bis[(triisopropylsilanyl)ethynyl]-1,5-dithia-s-indacene (0.20 g, 0.28 mmol), tetrakis(triphenylphosphine)palladium (0.05 g) and THF (10 ml), then 4,4,5,5-tetramethyl-2-( thieno[3,2-b]thiophen-2-yl)-[1,3,2]-dioxaborolane (0.23 g, 0.86 mmol) and potassium carbonate solution (0.48 g, 3.5 mmol, in water 3 ml). This reaction mixture is degassed with nitrogen for 5 min, then heated in microwave reactor at 100° C. for 120 s, 120° C. for 120 s and 140° C. for 900 s. The mixture is poured into water and the precipitate collected by filtration and purified by column chromatography, eluting with THF to give brown solid, which was recrystallised with THF/acetonitrile, to afford brown crystals (0.19 g, 83%). ¹H NMR (300 Hz, CDCl₃): δ (ppm) 7.65 (s, 2H, Ar—H), 7.51 (s, 2H, Ar—H), 7.39 (d, J=5.1 Hz, 2H, Ar—H), 7.24 (d, J=5.1 Hz, 2H, Ar—H), 1.27 (m, 42H, CH and CH₃); ¹³C NMR (75 Hz, CDCl₃): 140.2, 139.9, 139.32, 139.28, 139.1, 138.9, 128.3, 119.6, 118.9, 117.8, 111.3, 102.4, 102.2, 18.8, 11.5.

### Example 5

Compound (5), 2,6-bis(phenylvinyl)-4,8-bis[(triisopropylsilanyl)-ethynyl]-1,5-dithia-s-indacene, is prepared as follows:

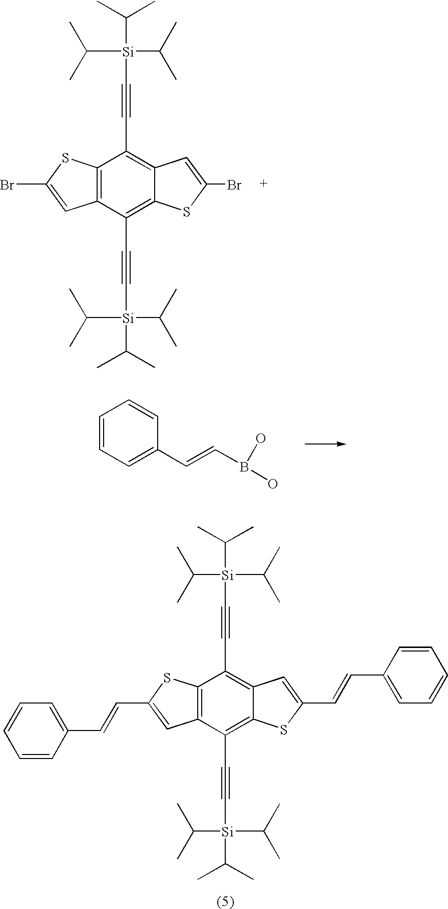

To a 20-ml microwave reaction tube is charged 2,6-dibromo-4,8-bis[(triisopropylsilanyl)ethynyl-1,5-dithia-s-indacene (0.20 g, 0.28 mmol), tetrakis(triphenylphosphine)palladium (0.05 g) and THF (10 ml), then trans-2-phenylvinylboronic acid (0.13 g, 0.88 mmol) and potassium carbonate solution (0.5 g, 3.5 mmol, in 3 ml water). This reaction mixture is degassed with nitrogen for 5 min, then heated in microwave reactor (Personal Chemisty Creator) at 100° C. for 120 s, 120° C. for 120 s and 140° C. for 900 s. The mixture is poured into water and stirred for 10 min. The precipitate is collected by filtration and purified by column chromatography, eluting with THF to give brown solid, which was recrystallised with THF/acetonitrile, to afford brown crystals (0.15 g, 71%). ¹H NMR (300 Hz, CDCl₃): δ (ppm) 7.56 (m, 4H, Ar—H), 7.47 (s, 2H, Ar—H), 7.29-7.41 (m, 8H, Ar—H and ═CH), 7.03 (d, 2H, J=16.1 Hz, ═CH), 1.26 (m, 42H, CH and CH₃); ¹³C NMR (75 Hz, CDCl₃): δ (ppm) 144.4, 140.0, 139.3, 136.5, 131.9, 128.8, 128.3, 126.8, 122.5, 122.4, 111.3, 102.4, 101.8, 18.9, 11.4.

### Example 6

Compound (6) is prepared as follows:

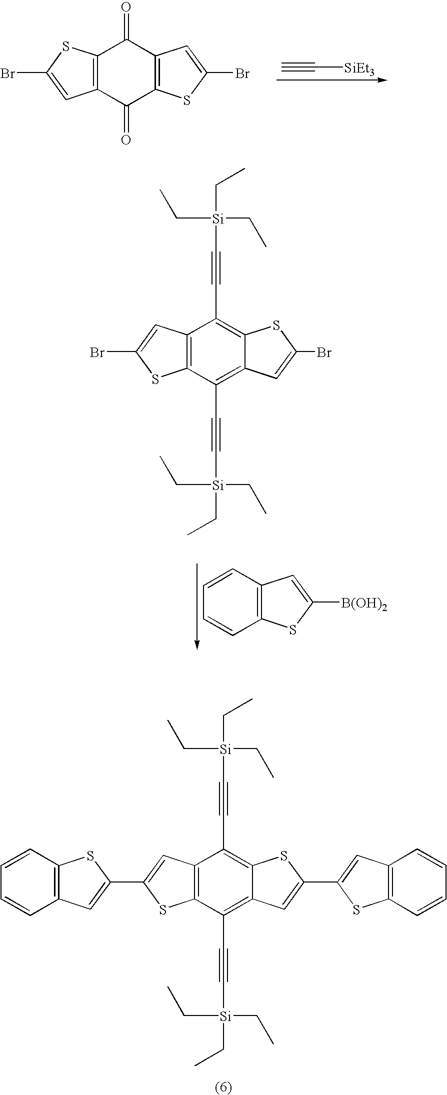

### Step 6.1: 2,6-Dibromo-4,8-bis[(triethylsilanyl)ethynyl]-1,5-dithia-s-indacene

To a solution of triethylsilylacetylene (7.70 g, 53.2 mmol) in 1,4-dioxane (200 ml) is added n-BuLi (1.60 M in hexanes₁ 33.2 ml, 53.1 mmol) dropwise at RT. This solution is stirred for 30 min, followed by the addition of 2,6-dibromo-1,5-dithia-s-indacene-4,8-dione (4.01 g, 10.6 mmol). The resulting mixture is heated at reflux overnight (˜17 h). After cooling, solid SnCl₂ (10.0 g), then conc. HCl solution (15 ml) is added, and the mixture stirred for 1 h. Water is added and the precipitate is collected by filtration and washed with acetonitrile to give product as brown solid (3.23 g, 49%). ¹H NMR (300 Hz, CDCl₃): δ (ppm) 7.52 (s, 2H, Ar—H), 1.13 (t, J=7.7 Hz, 18H, CH₃), 0.78 (q, J=7.7 Hz, 12H, CH₂); ¹³C NMR (75 Hz, CDCl₃): δ (ppm) 141.9, 137.8, 125.9, 117.5, 110.4, 104.1, 100.7, 7.5, 4.5.

### Step 6.2: 2,6-bisbenzo(b)thiophen-2-yl-4,8-bis[(triethyl-silanyl)ethynyl]-1,5-dithia-s-indacene

To a 20-ml microwave reaction tube is charged 2,6-dibromo-4,8-bis[(triethylsilanyl)ethynyl]-1,5-dithia-s-indacene (0.31 g, 0.50 mmol), tetrakis(triphenylphosphine)palladium (0.05 g) and THF (10 ml), then benzo(b)thiophene-2-bronic acid (0.26 g, 1.46 mmol) and potassium carbonate solution (0.8 g, 5.80 mmol, in 3 ml water). This reaction mixture is degassed with nitrogen for 5 min, then heated in microwave reactor (Personal Chemisty Creator) at 100° C. for 120 s, 120° C. for 120 s and 140° C. for 900 s. The mixture is poured into water and stirred for 10 min. The precipitate is collected by filtration and washed with water and diethyl ether, to give a red solid (0.27 g, 75%). ¹H NMR (300 Hz, CDCl₃): δ (ppm) 7.82 (m, 4H, Ar—H), 7.72 (s, 2H, Ar—H), 7.59 (s, 2H, Ar—H), 7.37 (m, 4H, Ar—H), 1.21 (t, J=7.7 Hz, 18H, CH₃), 0.84 (q, J=7.7 Hz, 12H, CH₂); ¹³C NMR (75 Hz, CDCl₃): δ (ppm) 140.5, 140.2, 139.8, 139.3, 138.9, 137.0, 125.2, 124.9, 123.9, 122.24, 122.21, 120.5, 111.5, 103.6, 101.4, 7.8, 4.5.

### Example 7

Compound (7), 2,6-bis(phenylvinyl)-4,8-bis[(triethylsilanyl)ethynyl]-1,5-dithia-s-indacene, is prepared as follows:

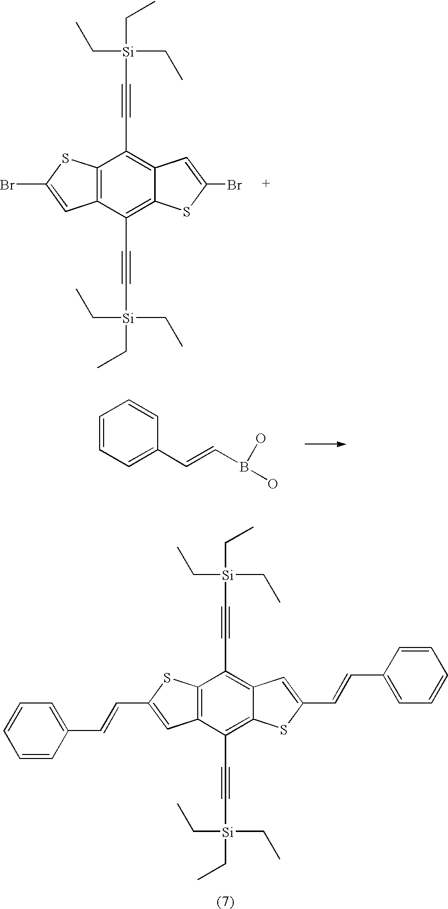

To a 20-ml microwave reaction tube is charged 2,6-dibromo-4,8-bis[(triethylsilanyl)ethynyl]-1,5-dithia-s-indacene (0.31 g, 0.50 mmol), tetrakis(triphenylphosphine)palladium (0.05 g) and THF (10 ml), then trans-2-Phenylvinylboronic acid (0.23 g, 1.6 mmol) and potassium carbonate solution (0.8 g, 5.8 mmol, in 3 ml water). This reaction mixture is degassed with nitrogen for 5 min, then heated in microwave reactor (Personal Chemisty Creator) at 100° C. for 120 s, 120° C. for 120 s and 140° C. for 900 s. The mixture is poured into water and stirred for 10 min. The precipitate is collected by filtration and washed with water and diethyl ether, to give red solid, which is recrystallised with THF/acetonitrile, to afford red crystals (0.18 g, 55%). ¹H NMR (300 Hz, CDCl₃): δ (ppm) 7.55 (d, J=7.2 Hz, 4H, Ar—H), 7.47 (s, 2H, Ar—H), 7.29-7.41 (m, 8H, Ar—H and ═CH), 7.03 (d, J=16.0 Hz, 2H, ═CH), 1.18 (t, J=7.5 Hz, 18H, CH₃), 0.82 (q, J=7.5 Hz, 12H, CH₂); ¹³C NMR (75 Hz, CDCl₃): δ (ppm) 144.4, 139.9, 139.2, 136.5, 131.9, 128.8, 128.3, 126.8, 122.6, 122.4, 111.2, 102.8, 101.7, 7.8, 4.6.

1. Compounds of formula I 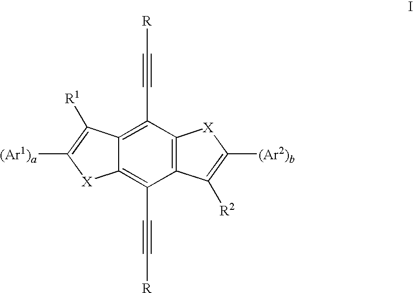
wherein
X is S or Se,
R is in each occurrence independently of one another R³ or —SiR′R″R′″,
Ar¹ and Ar² are independently of each other an aryl or heteroaryl group that is optionally substituted with one or more groups R³, or denote —CX¹═CX²— or —C≡C—,
a and b are independently of each other 1, 2, 3, 4 or 5,
R¹, R² and R³ are independently of each other H, halogen or straight chain, branched or cyclic alkyl with 1 to 40 C-atoms, which may be unsubstituted, mono- or poly-substituted by F, Cl, Br, I or CN, it being also possible for one or more non-adjacent CH₂ groups to be replaced, in each case independently from one another, by —O—, —S—, —NH—, —NR⁰—, —SiR⁰R⁰⁰—, —CO—, —COO—, —OCO—, —OCO—O—, —S—CO—, —CO—S—, —CH≡CH— or —C≡C— in such a manner that O and/or S atoms are not linked directly to one another, or optionally substituted aryl or heteroaryl, or P-Sp-,
P is a polymerisable or reactive group,
Sp is a spacer group or a single bond,
X¹ and X² are independently of each other are independently of each other H, F, Cl or CN,
R⁰ and R⁰⁰ are independently of each other H or alkyl with 1 to 12 C-atoms, and
R′, R″ and R′″ are identical or different groups selected from H, straight chain, branched or cyclic C₁-C₄₀-alkyl or C₁-C₄₀-alkoxy, C₆-C₄₀-aryl, C₆-C40-arylalkyl, or C₆-C₄₀-arylalkyloxy, wherein all these groups are optionally substituted with one or more halogen atoms.

2. Compounds according to claim 1, characterized in that R′, R″ and R′″ are each independently selected from optionally substituted C₁₋₁₀-alkyl and optionally substituted C₆₋₁₀-aryl.

3. Compounds according to claim 1, characterized in that Ar¹ and Ar² are independently of each other selected from phenyl in which, in addition, one or more CH groups may be replaced by N, naphthalene, pyridine, naphthalene-2-yl, thiophene-2-yl, thieno[2,3b]thiophene-2-yl, benzo(b)thiophene-2-yl, all of which are optionally mono or polysubstituted with L, wherein L is F, Cl, Br, or an alkyl, alkoxy, alkylcarbonyl, alkylcarbonyloxy or alkoxycarbonyl group with 1 to 12 C atoms, wherein one or more H atoms are optionally replaced by F or Cl.

4. Compounds according to claim 1, characterized in that R¹, R² and R³ are selected from C₁-C₂₀-alkyl that is optionally substituted with one or more fluorine atoms, C₁-C₂₀-alkenyl, C₁-C₂₀-alkynyl, C₁-C₂₀-thioalkyl, C₁-C₂₀-silyl, C₁-C₂₀-ester, C₁-C₂₀-amino, C₁-C₂₀-fluoroalkyl, and optionally substituted aryl or heteroaryl.

5. Compounds according to claim 1, characterized in that Ar¹ and Ar² are substituted by at least one group R³ that denotes P-Sp-.

6. Compounds according to claim 1, characterized in that they are selected from the following subformulae 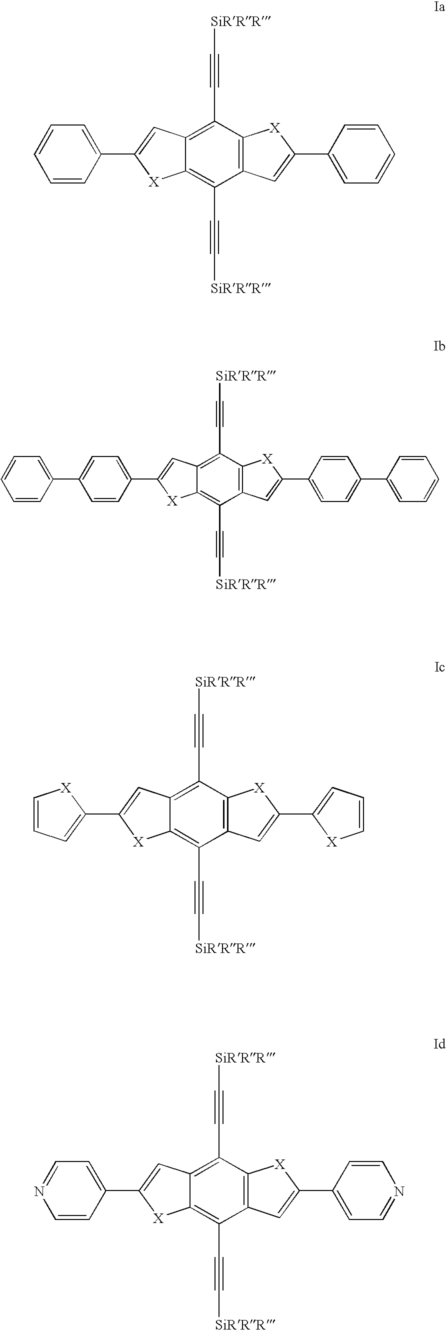 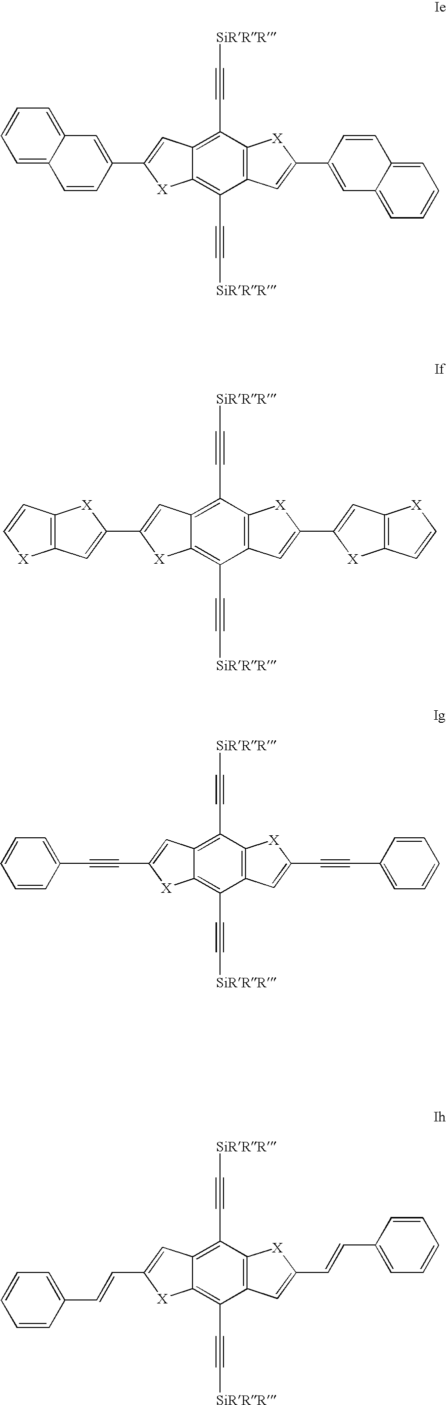 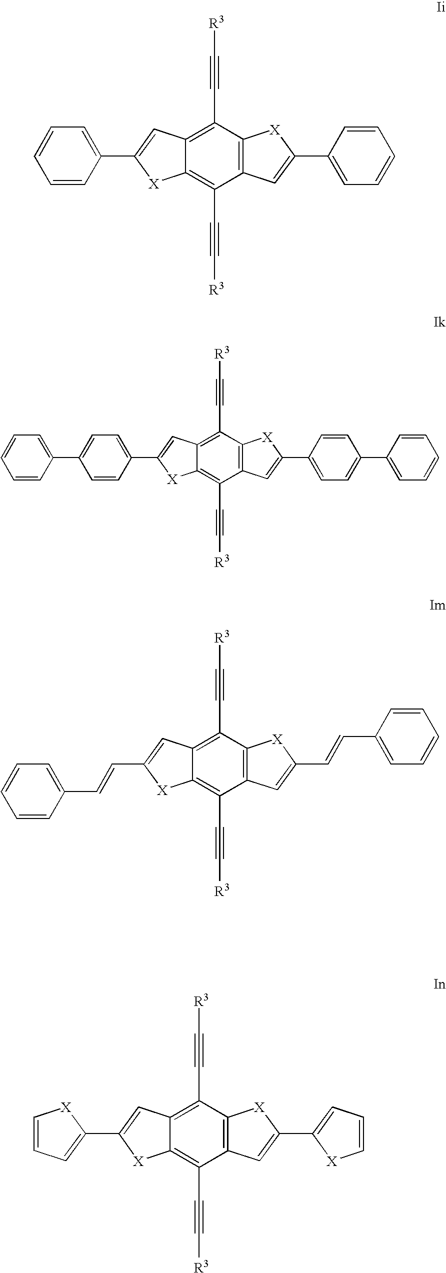 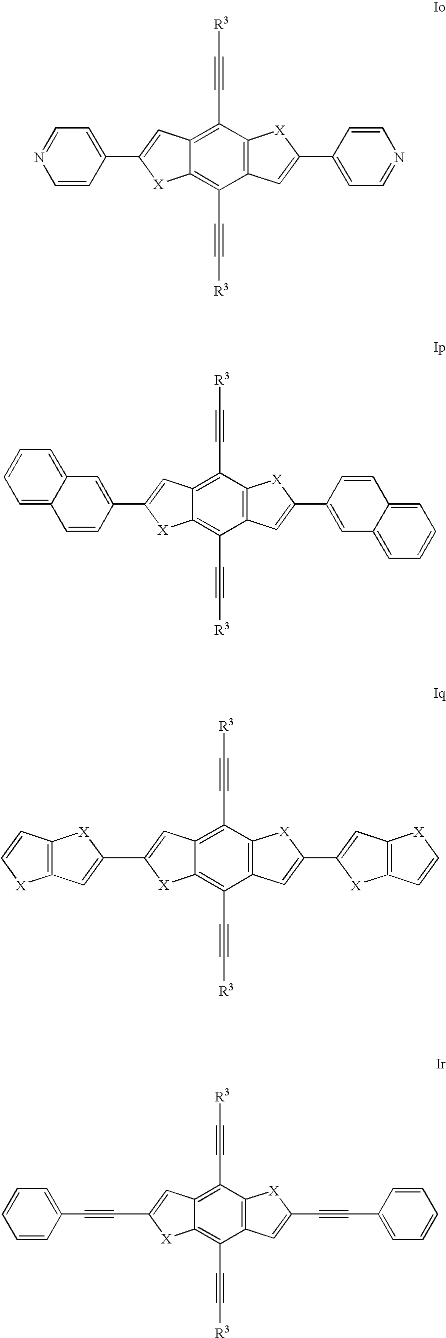 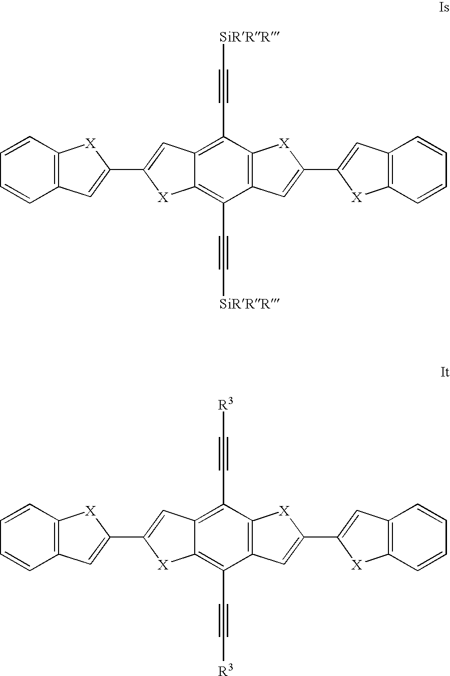
wherein X, R³, R′, R″ and R′″ have the meanings given in claim 1, and wherein the benzene rings and the thiophene rings are optionally substituted with one or more groups R³ as defined in claim 1.

7. Polymerisable mesogenic or liquid crystalline material comprising one or more compounds according to claim 1 comprising at least one polymerisable group, and optionally comprising one or more further polymerisable compounds.

8. Anisotropic polymer film obtainable by aligning a polymerisable liquid crystalline material according to claim 7 in its liquid crystal phase into macroscopically uniform orientation and polymerising or crosslinking the material to fix the oriented state.

9. Formulation comprising one or more compounds according to claim 1, one or more solvents, and optionally one or more organic binders.

10. Formulation according to claim 9, characterized in that it comprises one or more semiconducting binders.

11. An electronic, optical or electrooptical component or device comprising a compound, material, polymer or formulation according to claim 1.

12. Electronic, optical or electrooptical component or device comprising one or more compounds, materials, polymers or formulations according to claim 1.

13. Device according to claim 12, characterized in that it is an organic field effect transistor (OFET), thin film transistor (TFT), component of integrated circuitry (IC), radio frequency identification (RFID) tag, organic light emitting diode (OLED), electroluminescent display, flat panel display, backlight, photodetector, sensor, logic circuit, memory element, capacitor, photovoltaic (PV) cell, charge injection layer, Schottky diode, planarising layer, antistatic film, conducting substrate or pattern, photoconductor or electrophotographic element.

14. Compound, material or polymer according to claim 1, characterized in that it is oxidatively or reductively doped to form conducting ionic species.

15. Charge injection layer, planarising layer, antistatic film or conducting substrate or pattern for electronic applications or flat panel displays, comprising a compound, material or polymer according to claim 14.

16. Method of preparing a compound according to claim 1, by
a1) subjecting a 4,8-dehydrobenzo[1,2-b:4,5-b′]dithiophene-4,8-dione, or 4,8-dehydrobenzo[1,2-b:4,5-b′]diselenophene-4,8-dione, to double lithiation with a hindered lithium amide base, followed by reaction with an electrophillic source of bromine, or
a2) synthesizing 2,6-dibromo-4,8-dehydrobenzo[1,2-b:4,5-b′]dithiophene-4,8-dione, or 2,6-dibromo-4,8-dehydrobenzo[1,2-b:4,5-b′]diselenophene-4,8-dione, by reaction of 2,5-dibromo-3-thiophene carboxylic acid dialkyl amide, or 2,5-dibromo-3-selenophene carboxylic acid dialkyl amide respectively, with an organolithium or organomagnesium reagent and
b) introducing aryl or heteroaryl groups into the 2,6-positions of the product of step a1) or a2) by standard Suzuki, Stille, Negishi or Kumada coupling with an aryl boronic acid or ester, an aryl organotin reagent, an aryl organozinc reagent or an organomagnesium reagent, respectively, in the presence of a suitable palladium or nickel catalyst and
c) introducing an alkynyl group, alkenyl or alkyl group into the 4,8 positions of the product of step b) by reacting it with an excess of the appropriate alkyl, alkenyl or alkynyl organolithium or organomagnesiun reagent followed by reduction of the resulting diol interemediate or
b1) introducing an alkynyl group, alkenyl or alkyl group into the 4,8 positions of the product of step a1) or a2) by reacting it with an excess of the appropriate alkyl, alkenyl organolithium or organomagnesium reagent followed by reduction of the resulting diol interemediate and
c1) introducing aryl or heteroaryl groups into the product of step b1 by standard Suzuki, Still, Negishi or Kumade coupling with an aryl boronic acid or ester, an aryl organotin reagent, an organozinc reagent or an organomagnesium reagent respectively, in the presence of a suitable palladium or nickel catalyst. or
d) introducing alkenyl or alkynyl aryl or heteroaryl groups into the 2,6-positions of the product of step b1) by standard Heck, Sonogashira, or Suzuki coupling with an aryl alkene group, an aryl alkyne group or an aryl alkenyl boronic acid or esters respectively in the presence of a suitable palladium or nickel catalyst.
